(19) United States
(12) Patent Application Publication
(10) Pub. No.: US 2024/0429728 A1
(43) Pub. Date: Dec. 26, 2024

(54) Systems and Methods for Controlling Charging and Maintenance of a Battery Using a Charger

(71) Applicant: Milwaukee Electric Tool Corporation, Brookfield, WI (US)

(72) Inventors: Jonathan E. Abbott, Milwaukee, WI (US); Matthew R. Polakowski, Greenfield, WI (US); Andrew S. Lentz, Wauwatosa, WI (US); David W. Siegler, New Berlin, WI (US)

(21) Appl. No.: 18/704,038

(22) PCT Filed: Oct. 26, 2022
(86) PCT No.: PCT/US2022/047882

§ 371 Date: Apr. 23, 2024

Related U.S. Application Data
(60) Provisional application No. 63/272,587, filed on Oct. 27, 2021.

(51) Int. Cl. H02J 7/00; H01M 10/44; H01M 10/613; H01M 10/615; H01M 10/6235

(52) U.S. Cl. CPC H02J 7/0071; H01M 10/443; H01M 10/613; H01M 10/615; H01M 10/6235; H02J 7/00034; H02J 7/0045

(57) ABSTRACT

A power tool battery charger includes a battery pack interface configured to receive a power tool battery pack and provide charging current to the battery pack and an electronic controller including a processor. The electronic controller can be configured to receive a set of data associated with the power tool battery pack and use of the power tool battery pack, determine a time for performing a maintenance procedure based on the set of data, determine one or more maintenance procedures to be performed on the power tool battery pack based on the set of data, and perform the one or more maintenance procedures on the power tool battery pack at the determined time. The maintenance procedures may include determining a maximum capacity of the battery pack, cell balancing of the battery pack, cooling the battery pack or heating the battery pack.

### RELATED APPLICATIONS

The present application is based on and claims priority from U.S. Patent Application No. 63/272,587, filed on Oct. 27, 2021, the entire disclosure of which is incorporated herein by reference.

### BACKGROUND

Power tools are typically powered by portable battery packs. These battery packs range in battery chemistry and nominal voltage and can be used to power numerous power tools and electrical devices. A power tool battery charger includes one or more battery charger circuits that are connectable to a power source and operable to charge one or more power tool battery packs connected to the power tool battery charger.

### SUMMARY

In accordance with an embodiment, a power tool battery charger includes a battery pack interface configured to receive a power tool battery pack and provide charging current to the battery pack and an electronic controller including a processor. The electronic controller can be configured to receive a set of data associated with the power tool battery pack and use of the power tool battery pack, determine a time for performing a maintenance procedure based on the set of data, determine one or more maintenance procedures to be performed on the power tool battery pack based on the set of data, and perform the one or more maintenance procedures on the power tool battery pack at the determined time.

In accordance with another embodiment, a method for performing a maintenance procedure on a power tool battery pack includes receiving, using an electronic controller, a set of data associated with the power tool battery pack and use of the power tool battery pack, determining, using the electronic controller, a time for performing a maintenance procedure based on the set of data, determining, using the electronic controller, one or more maintenance procedures to be performed on the power tool battery pack based on the set of data, and performing, using a power tool battery charger, the one or more maintenance procedures on the power tool battery pack at the determined time.

In accordance with another embodiment, a power tool battery charger includes a battery pack interface configured to receive a power tool battery pack and provide charging current to the battery pack and an electronic controller including a processor. The electronic controller can be configured to receive a set of data associated with the power tool battery pack and use of the power tool battery pack, determine at least one recommendation regarding a non-use mode of the power tool battery pack based on the set of data, and display, on a display in communication with the electronic controller, the at least one recommendation regarding a non-use mode of the power tool battery pack.

In accordance with another embodiment, a method for determining recommendations for a non-use mode for a power tool battery pack includes receiving, using an electronic controller, a set of data associated with the power tool battery pack and use of the power tool battery pack, determining, using the electronic controller, at least one recommendation regarding a non-use mode of the power tool battery pack based on the set of data, and displaying the at least one recommendation regarding a non-use mode of the power tool battery pack using a display.

### BRIEF DESCRIPTION OF THE DRAWINGS

The accompanying drawings, which are incorporated in and form a part of this specification, illustrate embodiments of the disclosure and, together with the description, serve to explain principles of the embodiments:

FIG. 1 illustrates a first example of a power tool battery charger system in accordance with an embodiment;

FIG. 2 illustrates a second example of a power tool battery charger system in accordance with an embodiment;

FIG. 3 illustrates a third example of a power tool battery charger system in accordance with an embodiment;

FIGS. 4A and 4B illustrate a fourth example of a power tool battery charger system in accordance with an embodiment;

FIG. 5 illustrates a fifth example of a power tool battery charger system in accordance with an embodiment;

FIG. 6 illustrates an example of a power tool battery pack in accordance with an embodiment;

FIG. 7A is a block diagram of a charging system for a power tool battery pack in accordance with an embodiment;

FIG. 7B is a block diagram of an example charger controller of the power tool battery charger of FIG. 7A in accordance with an embodiment;

FIG. 7C is a block diagram of an example machine learning controller of the power tool battery charger of FIG. 7A in accordance with an embodiment;

FIG. 8 illustrates a method for determining a maintenance procedure for a power tool battery pack in accordance with an embodiment;

FIG. 9 illustrates a method for performing a capacity check of a power tool battery pack in accordance with an embodiment;

FIG. 10 illustrates a method for determining recommendations for a non-use mode of a power tool battery pack in accordance with an embodiment;

FIGS. 11A-C illustrate examples of power tool battery pack chargers in according to some embodiments; and

FIGS. 12A-F illustrate examples of power tool battery packs according to some embodiments.

### DETAILED DESCRIPTION

Some power tool battery chargers include sensors and a control system that use hard-coded thresholds to, for example, change or adjust the operation of the power tool battery charger. For example, a sensor may detect that a temperature is above a predetermined, hard-coded threshold. The power tool battery charger may then cease operation of a charging circuit to protect the battery pack and/or power tool battery charger. While these type of thresholds may be simple to implement and provide some benefits to the operation of a power tool battery charger, these type of hard-coded thresholds cannot adapt to changing conditions or applications during which the power tool battery charger is operated, and may not ultimately be helpful in detecting and responding to more complicated conditions, such as, for example, determining when to perform a maintenance procedure on a power tool battery pack, determining whether to perform a maintenance procedure on a power tool battery, identifying maintenance procedures to perform on a power tool battery pack, determining recommendations regarding a non-use mode for a power tool battery pack, and so on.

By knowing when a user might need their battery charged, a power tool battery charger can be optimized for its charging and other power tool battery/power tool battery charger features (e.g., cell balancing, maintenance/inspection). Additionally, by understanding the use patterns of the user(s), power tool batteries, and/or other factors (e.g., time of day, day of week, cost of electricity, jobsite needs, weather, expected availability of additional energy (e.g., availability of AC outlets at night, additional battery supply, etc.), and the like), a power tool battery charger can include more informed control logic, provide improved charging, provide optimized features such as cell balancing, capacity checks, cooling packs, heating packs, control ambient environmental conditions of the charger and battery pack (e.g., temperature, humidity, lighting, etc.) and the like, and inform when to implement and help implement various charger features such as maintenance procedures, non-use modes, and conditioning.

Described herein are various systems in which a machine learning controller, or artificial intelligence controller, is utilized to control a feature or function of the power tool battery charger and/or battery. For example, the machine learning controller and/or artificial intelligence controller, instead of or in addition to implementing hard-coded thresholds determined and programmed by, for example, an engineer, detects conditions based on power tool device data that may include usage data, maintenance data, power source data, sensor data, environmental data, operator data, location data, among other data, which may be associated with a power tool device, such as a power tool battery charger, a battery pack, and/or a power tool.

The power tool device data may be collected while the power tool battery charger, battery pack, and/or power tool are being used, or during previous uses of the power tool battery charger, battery pack, and/or power tool. In some embodiments, the machine learning controller and/or artificial intelligence controller determines adjustable parameters and/or thresholds that are used to operate the power tool battery charger. Accordingly, the parameters, thresholds, conditions, or combinations thereof are based on previous operation of the same type of power tool battery charger and may change based on input received from the user and further operations of the power tool battery charger (e.g., in response to power tool device data acquired while operating the power tool battery charger, battery pack, and/or power tool).

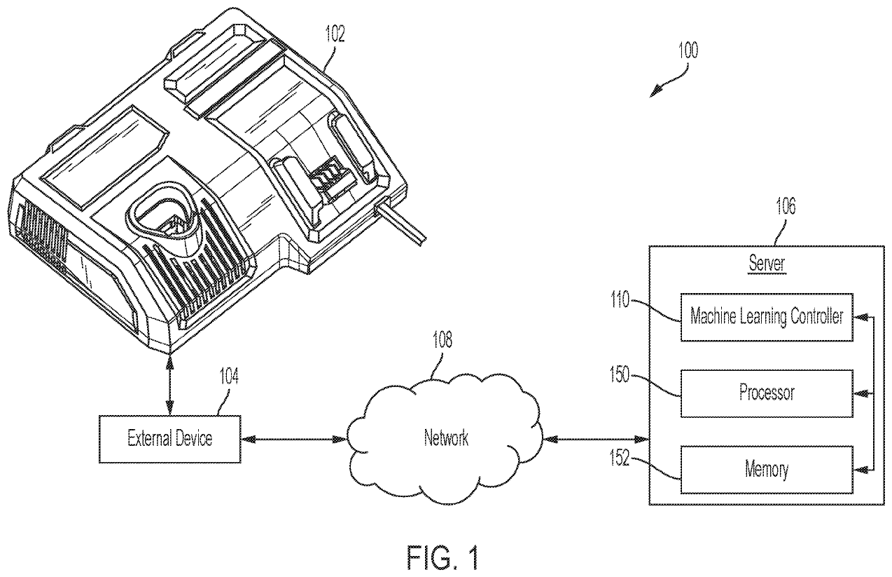

FIG. 1 illustrates a first power tool battery charger system 100 in accordance with an embodiment. The first power tool battery charger system 100 includes a power tool battery charger 102, an external device 104, a server 106, and a network 108. The power tool battery charger 102 includes various sensors and devices that collect usage information, or data, during the operation of the power tool battery charger 102. The usage information, or data, may alternatively be referred to as operational information, or data, of the power tool battery charger 102, and refers to, for example, data regarding the operation of the power tool battery charger (e.g., current, position, acceleration, temperature, usage time, and the like), the operating mode of the power tool battery charger 102 (e.g., pre-charge mode, constant current regulation mode, constant voltage regulation mode, fast charge mode, operation time in each mode, frequency of operation in each mode, and the like), conditions encountered during operation (e.g., battery and/or charger overheating, whether circuit breakers on a connected circuit are being tripped, voltage falloff, and the like), and other aspects (e.g., state of charge of the battery, connected power source type, cost of electricity supplied from the connected power source, and the like). As described above, other power tool device data may also be collected by the power tool battery charger 102, including other usage data, maintenance data, feedback data, power source data, environmental data, operator data, location data, amongst other data.

In the illustrated embodiment, the power tool battery charger 102 communicates with the external device 104. The external device 104 may include, for example, a smartphone, a tablet computer, a cellular phone, a laptop computer, a smart watch, and the like. The power tool battery charger 102 communicates with the external device 104, for example, to transmit at least a portion of the usage information for the power tool battery charger 102, to receive configuration information for the power tool battery charger 102, or a combination thereof. In some embodiments, the external device may include a short-range transceiver to communicate with the power tool battery charger 102, and a long-range transceiver to communicate with the server 106. In the illustrated embodiment, the power tool battery charger 102 also includes a transceiver to communicate with the external device 104 via, for example, a short-range communication protocol such as Bluetooth® or Wi-Fi®. In some embodiments, the external device 104 bridges the communication between the power tool battery charger 102 and the server 106. For example, the power tool battery charger 102 may transmit operational data to the external device 104, and the external device 104 may forward the operational data from the power tool battery charger 102 to the server 106 over the network 108.

The network 108 may be a long-range wireless network such as the Internet, a local area network (“LAN”), a wide area network (“WAN”), or a combination thereof. In other embodiments, the network 108 may be a short-range wireless communication network, and in yet other embodiments, the network 108 may be a wired network using, for example, USB cables, or include a combination of long-range, short-range, and/or wired connections. Similarly, the server 106 may transmit information to the external device 104 to be forwarded to the power tool battery charger 102. In some embodiments, the power tool battery charger 102 is equipped with a long-range transceiver instead of or in addition to the short-range transceiver. In such embodiments, the power tool battery charger 102 communicates directly with the server 106. In some embodiments, the power tool battery charger 102 may communicate directly with both the server 106 and the external device 104. In such embodiments, the external device 104 may, for example, generate a graphical user interface to facilitate control and programming of the power tool battery charger 102, while the server 106 may store and analyze larger amounts of operational data for future programming or operation of the power tool battery charger 102. In other embodiments, however, the power tool battery charger 102 may communicate directly with the server 106 without utilizing a short-range communication protocol with the external device 104.

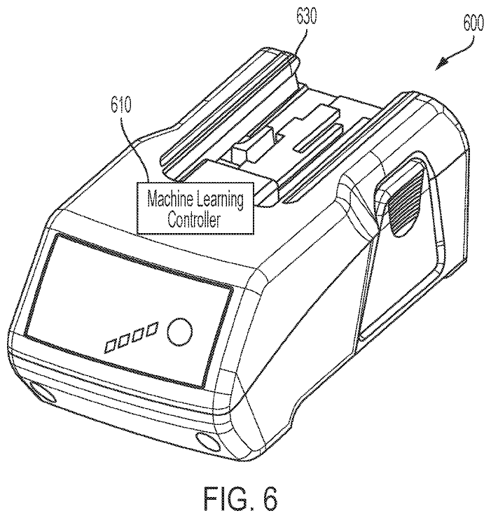

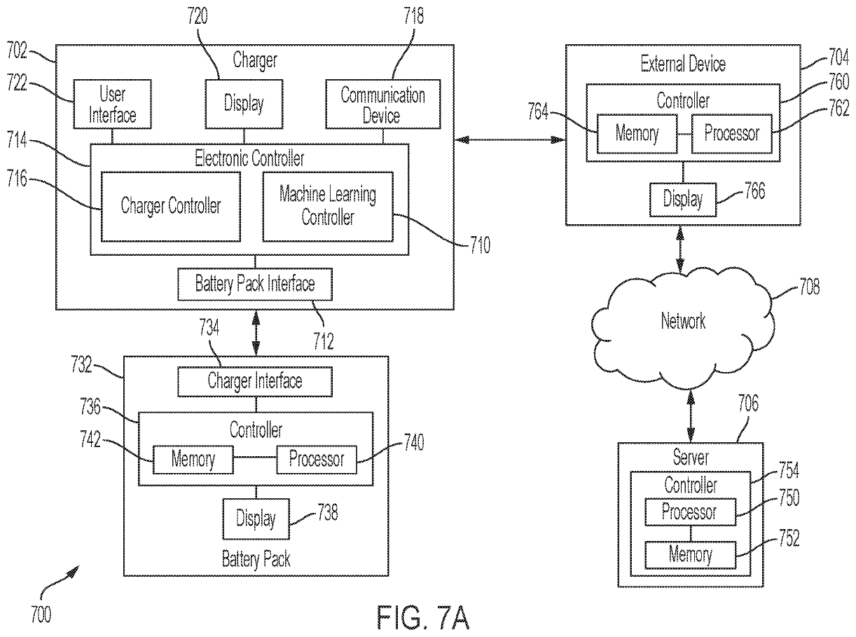

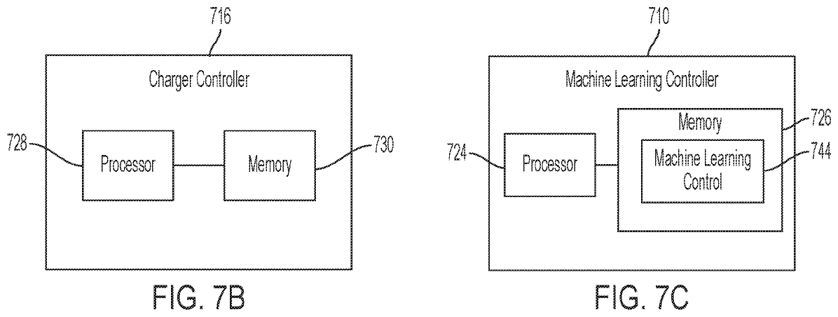

The server 106 includes a server electronic control assembly having a server processor 150, a server memory 152, a transceiver, and a machine learning controller 110. The transceiver allows the server 106 to communicate with the power tool battery charger 102, the external device 104, or both. The server processor 150 receives usage data from the power tool battery charger 102 (e.g., via the external device 104), stores the received usage data in the server memory 152, and, in some embodiments, uses the received usage data for constructing, training, adjusting, or executing a machine learning controller 110. That is, the machine learning controller 110 may be software or a set of instructions executed by the server processor 150 to implement the functionality of the machine learning controller 110 described herein. In some examples, the machine learning controller 110 includes a separate processor and memory (e.g., as described with respect to FIG. 7C) to execute the software or instructions to implement the functionality of the machine learning controller 110 described herein.

The machine learning controller 110 implements a machine learning program, algorithm or model, or can additionally or alternatively implement other artificial intelligence programs, algorithms, or models. In some implementations, the machine learning controller 110 is configured to construct a model (e.g., building one or more algorithms) based on example inputs, which may be done using supervised learning, unsupervised learning, reinforcement learning, ensemble learning, active learning, transfer learning, or other suitable learning techniques for machine learning and/or artificial intelligence programs, algorithms, or models.

As a non-limiting example, the machine learning controller 110 can construct a machine learning program, algorithm, or model using supervised learning techniques, or alternatively can access a machine learning program, algorithm, or model previously constructed using supervised learning techniques. Supervised learning involves presenting a computer program with example inputs and their actual outputs (e.g., categorizations). In these instances, the machine learning controller 110 is configured to learn a general rule or model that maps the inputs to the outputs based on the provided example input-output pairs.

The machine learning algorithm may be configured to implement various different types of machine learning or other artificial intelligence algorithms or models. For example, the machine learning controller 110 may implement decision tree learning, association rule learning, artificial neural networks, recurrent neural networks, long short-term memory models, inductive logic programming, support vector machines, clustering, Bayesian networks, reinforcement learning, representation learning, similarity and metric learning, sparse dictionary learning, genetic algorithms, k-nearest neighbors (“KNN”) classifiers, among others, such as those listed in Table 1 below.

TABLE 1

| | |
|---|---|
| Recurrent Models | Recurrent neural networks (“RNNs”), long short-term memory |
| | (“LSTM”) models, gated recurrent unit (“GRU”) models, |
| | Markov processes, reinforcement learning |
| Non-Recurrent Models | Deep neural networks (“DNNs”), convolutional neural networks |
| | (“CNNs”), support vector machines (“SVMs”), anomaly |
| | detection (e.g., using principal component analysis (“PCA”), |
| | logistic regression, decision trees/forests, ensemble methods |
| | (e.g., combining models), polynomial/Bayesian/other |
| | regressions, stochastic gradient descent (“SGD”), linear |
| | discriminant analysis (“LDA”), quadratic discriminant analysis |
| | (“QDA”), nearest neighbors classifications/regression, naïve |
| | Bayes, etc. |

The machine learning controller 110 can be programmed and trained to perform a particular task. For example, in some embodiments, the machine learning controller 110 is trained to determine a time to perform a maintenance procedure for a power tool battery pack, determine a maintenance procedure to perform on the power tool battery pack, or a combination thereof, based on data regarding the operation of the power tool battery charger, the power tool battery pack, and/or a power tool, environmental conditions for the power tool battery pack charger, power tool battery pack, and/or a power tool, or other aspects. The task for which the machine learning controller 110 is trained may vary based on, for example, the current charge level of the battery pack, a selection from a user, charging patterns for a power tool battery charger and/or power tool battery pack, times of operation (e.g., days of week, times of day) of the power tool battery pack charger and/or power tool battery pack, temperature of the surrounding environment, maintenance history of the power tool battery pack, and the like.

Similarly, the way in which the machine learning controller 110 is trained also varies based on the particular task. For instance, the training examples, or data, used to train the machine learning controller 110 may include different information based on the task of the machine learning controller 110. As a non-limiting example in which the machine learning controller 110 is configured to determine a time to perform a maintenance procedure for a power tool battery pack based on when a power tool battery pack is in use, each training example may include a set of inputs such as operation time of the power tool battery pack (e.g., how long the battery pack is used each session, the amount of time between sessions of battery pack usage, and the like), the frequency with which the battery pack is being used, and the like. Each training example generally also includes a specified output. For example, when the machine learning controller 110 is trained to indicate when a power tool battery pack is in use, a training example may have an output that includes one or more time periods during which the power tool battery pack is expected to be in use. Other training examples may include different values for each of the inputs and outputs indicating battery pack operation data. The training examples may be previously collected training examples from, for example, a plurality of power tool battery chargers, batteries, power tools, and the like. For example, the training examples may have been previously collected from, for example, several hundred power tool battery chargers of the same type over a span of, for example, one year.

A plurality of different training examples is provided to the machine learning controller 110. The machine learning controller 110 uses these training examples to generate a model (e.g., a rule, a set of equations, and the like) that helps categorize or estimate the output based on new input data. The machine learning controller 110 may weigh different training examples differently to, for example, prioritize different conditions or outputs from the machine learning controller 110. For example, a training example corresponding to a first set of battery pack operation data may be weighted more heavily than a training example corresponding to a second set of battery pack operation data in order to prioritize the first set of battery pack operation data relative to the second set of battery pack operation data. In some embodiments, the training examples are weighted differently by associating a different cost function or value to specific training examples or types of training examples.

In one example, the machine learning controller 110 implements an artificial neural network. The artificial neural network generally includes an input layer, one or more hidden layers or nodes, and an output layer. Typically, the input layer includes as many nodes as inputs provided to the machine learning controller 110. As described above, the number (and the type) of inputs provided to the machine learning controller 110 may vary based on the particular task for the machine learning controller 110. Accordingly, the input layer of the artificial neural network of the machine learning controller 110 may have a different number of nodes based on the particular task for the machine learning controller 110.

The input layer connects to the one or more hidden layers. The number of hidden layers varies and may depend on the particular task for the machine learning controller 110. Additionally, each hidden layer may have a different number of nodes and may be connected to the next layer differently. For example, each node of the input layer may be connected to each node of the first hidden layer. The connection between each node of the input layer and each node of the first hidden layer may be assigned a weight parameter. Additionally, each node of the neural network may also be assigned a bias value. However, each node of the first hidden layer may not be connected to each node of the second hidden layer. That is, there may be some nodes of the first hidden layer that are not connected to all of the nodes of the second hidden layer. The connections between the nodes of the first hidden layers and the second hidden layers are each assigned different weight parameters. Each node of the hidden layer is associated with an activation function. The activation function defines how the hidden layer is to process the input received from the input layer or from a previous input or hidden layer. These activation functions may vary and be based on not only the type of task associated with the machine learning controller 110, but may also vary based on the specific type of hidden layer implemented.

Each hidden layer may perform a different function. For example, some hidden layers can be convolutional hidden layers which can, in some instances, reduce the dimensionality of the inputs, while other hidden layers can perform more statistical functions such as max pooling, which may reduce a group of inputs to the maximum value, an averaging layer, among others. In some of the hidden layers, each node is connected to each node of the next hidden layer. Some neural networks including more than, for example, three hidden layers may be considered deep neural networks.

The last hidden layer in the artificial neural network is connected to the output layer. Similar to the input layer, the output layer typically has the same number of nodes as the possible outputs. In an example in which the machine learning controller 110 identifies a recommended non-use mode for a power tool battery pack, the output layer may include, for example, a number of different nodes, where each different node corresponds to a different set of power tool battery pack operation data. A first node may indicate that the recommended non-use mode may be a recycling mode, a second node may indicate that the non-use mode may be a disposal mode, and a third node may indicate that the non-use mode may be a storage mode. In some embodiments, the machine learning controller 110 then selects the output node with the highest value and indicates the corresponding recommended non-use mode to the power tool battery charger 102 (e.g., charger controller 716) or to the user. In some embodiments, the machine learning controller 110 may also select more than one output node.

The machine learning controller 110 or the electronic controller of the power tool battery charger 102 (e.g., charger controller 716) may then use the one or more outputs to control the power tool battery charger 102 (e.g., controlling the power tool battery charger 102 to perform a maintenance procedure on a power tool battery pack). For example, the machine learning controller 110 may determine a recommendation regarding a non-use mode of the power tool battery pack and may determine a conditioning procedure to use to place the power tool battery pack in the non-use mode. The machine learning controller 110 or the electronic controller of the power tool battery charger 102 may then, for example, control the power tool battery charger 102 to perform the conditioning procedure. The machine learning controller 110 or the electronic controller of the power tool battery charger 102 may implement different methods of combining the outputs from the machine learning controller 110.

During training, the artificial neural network receives the inputs for a training example and generates an output using the bias for each node, and the connections between each node and the corresponding weights. The artificial neural network then compares the generated output with the actual output of the training example. Based on the generated output and the actual output of the training example, the neural network changes the weights associated with each node connection. In some embodiments, the neural network also changes the weights associated with each node during training. The training continues until a training condition is met. The training condition may correspond to, for example, a predetermined number of training examples being used, a minimum accuracy threshold being reached during training and validation, a predetermined number of validation iterations being completed, and the like. Different types of training algorithms can be used to adjust the bias values and the weights of the node connections based on the training examples. The training algorithms may include, for example, gradient descent, Newton's method, conjugate gradient, quasi-Newton, Levenberg-Marquardt, among others.

In another example, the machine learning controller 110 implements a support vector machine or other suitable machine learning or artificial intelligence-based classifier to perform classification. The machine learning controller 110 may, for example, classify whether a power tool battery pack is suitable for a recycling mode. In such embodiments, the machine learning controller 110 may receive inputs such as remaining capacity of the power tool battery pack, data regarding past drops of the power tool battery pack, cell imbalance, quiescent current, charge rate, and the like. The machine learning controller 110 then defines a margin using combinations of some of the input variables (e.g., remaining capacity of the power tool battery pack, data regarding past drops of the power tool battery pack, cell imbalance, quiescent current, charge rate, and the like) as support vectors to maximize the margin. In some embodiments, the machine learning controller 110 defines a margin using combinations of more than one of similar input variables (e.g., remaining capacity of the power tool battery pack, cell imbalance, quiescent current, charge rate). The margin corresponds to the distance between the two closest vectors that are classified differently. For example, the margin corresponds to the distance between a vector representing a power tool battery pack suitable for a recycling mode and a vector that represents a power tool battery pack not suitable for a recycling mode. In some embodiments, the machine learning controller 110 uses more than one support vector machine to perform a single classification. For example, when the machine learning controller 110 classifies whether a power tool battery pack is suitable for a recycling mode, a first support vector machine may determine or classify whether a power tool battery pack is suitable for a recycling mode based on the remaining capacity of the power tool battery pack, while a second support vector machine may determine or classify whether a power tool battery pack is suitable for a recycling mode based on data regarding past drops of the power tool battery pack. The machine learning controller 110 may then determine whether a power tool battery pack is suitable for a recycling mode when both support vector machines classify the power tool battery pack as suitable for a recycling mode. In other embodiments, a single support vector machine can use more than two input variables and define a hyperplane that separates power tool battery packs suitable for a recycling mode from power tool battery packs not suitable for a recycling mode.

The training examples for a support vector machine include an input vector including values for the input variables (e.g., as remaining capacity of the power tool battery pack, data regarding past drops of the power tool battery pack, cell imbalance, quiescent current, charge rate, and the like), and an output classification indicating whether a power tool battery pack is suitable for a recycling mode. During training, the support vector machine selects the support vectors (e.g., a subset of the input vectors) that maximize the margin. In some embodiments, the support vector machine may be able to define a line or hyperplane that accurately separates power tool battery packs suitable for a recycling mode from power tool battery packs not suitable for a recycling mode. In other embodiments (e.g., in a non-separable case), however, the support vector machine may define a line or hyperplane that maximizes the margin and minimizes the slack variables, which measure the error in a classification of a support vector machine. After the support vector machine has been trained, new input data can be compared to the line or hyperplane to determine how to classify the new input data (e.g., whether a power tool battery packs is suitable for a recycling mode).

In other embodiments, as mentioned above, the machine learning controller 110 can implement different machine learning algorithms to make an estimation or classification based on a set of input data.

In the example of FIG. 1, the server 106 receives usage information from the power tool battery charger 102. In some embodiments, the server 106 uses the received usage information as additional training examples (e.g., when the actual value or classification is also known). In other embodiments, the server 106 sends the received usage information to the trained machine learning controller 110. The machine learning controller 110 then generates an estimated value or classification based on the input usage information. The server processor 150 then generates recommendations for future operations of the power tool battery charger 102. For example, the trained machine learning controller 110 may determine a recommendation regarding a non-use mode of the power tool battery pack based on, for, example usage data in the power tool device data. The server processor 150 may then identify a conditioning procedure to place the power tool battery pack in the recommended non-use mode. The server 106 may then transmit the suggested non-use mode and identified conditioning procedure to the external device 104. The external device 104 may display the suggested non-use mode and identified conditioning procedure (e.g., via a graphical user interface) and request confirmation from the user to implement the suggested non-use mode and identified conditioning procedure before forwarding the suggested non-use mode and identified conditioning procedure on to the power tool battery charger 102. In other embodiments, the external device 104 forwards the suggested non-use mode and identified conditioning procedure to the power tool battery charger 102 and displays the suggested non-use mode and identified conditioning procedure to inform the user of changes to the power tool battery pack implemented by the power tool battery charger 102.

In some embodiments, the power tool battery charger 102 periodically transmits the usage data to the server 106 based on a predetermined schedule (e.g., every eight hours). In other embodiments, the power tool battery charger 102 transmits the usage data after a predetermined period of inactivity (e.g., when the power tool battery charger 102 has been inactive for two hours), which may indicate that a session of operation has been completed. In some embodiments, the power tool battery charger 102 transmits the usage data in real time to the server 106 and may implement the updated thresholds and parameters in subsequent operations.

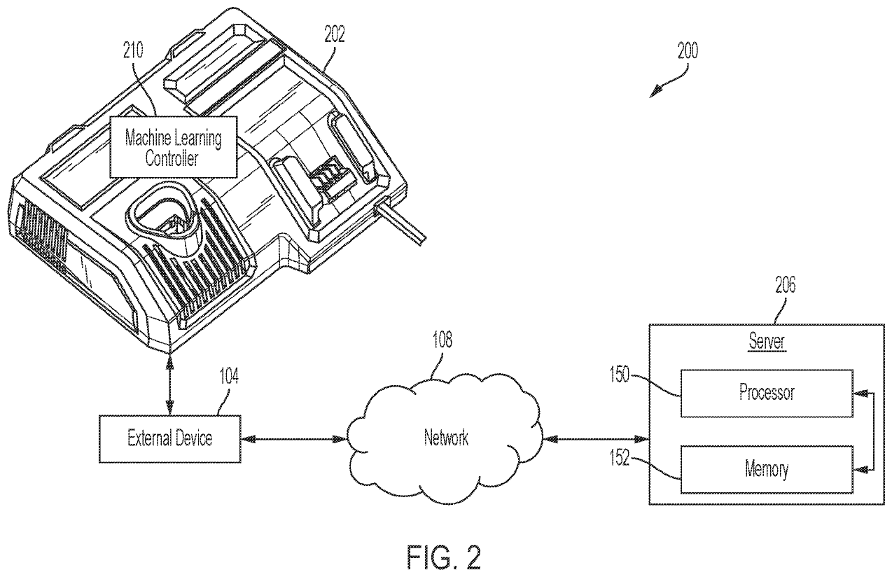

FIG. 2 illustrates a second power tool battery charger system 200 in accordance with an embodiment. The second power tool battery charger system 200 includes a power tool battery charger 202, the external device 104, a server 206, and a network 108. The power tool battery charger 102 is similar to that of the first power tool battery charger system 100 of FIG. 1 and collects similar usage information as that described with respect to FIG. 1. Unlike the power tool battery charger 102 of the first power tool battery charger system 100, the power tool battery charger 202 of the second power tool battery charger system 200 includes a static machine learning controller 210. The machine learning controller 210 may be software or a set of instructions executed by a processor of the charger 202 to implement the functionality of the machine learning controller 210 described herein. In some examples, the machine learning controller 110 includes a separate processor and memory (e.g., as described with respect to FIG. 7C) to execute the software or instructions to implement the functionality of the machine learning controller 210 described herein. In the illustrated embodiment, the power tool battery charger 202 receives the static machine learning controller 210 from the server 206 over the network 108 (in other words, receives the trained machine learning program, algorithm, or model to be executed by a processor of the charger 202). In some embodiments, the power tool battery charger 202 receives the static machine learning controller 210 during manufacturing, while in other embodiments, a user of the power tool battery charger 202 may select to receive the static machine learning controller 210 after the power tool battery charger 202 has been manufactured and, in some embodiments, after operation of the power tool battery charger 202. The static machine learning controller 210 is a trained machine learning controller similar to the trained machine learning controller 110 in which the machine learning controller 110 has been trained using various training examples and is configured to receive new input data and generate an estimation or classification for the new input data.

The power tool battery charger 202 communicates with the server 206 via, for example, the external device 104 as described above with respect to FIG. 1. The external device 104 may also provide additional functionality (e.g., generating a graphical user interface) to the power tool battery charger 202. The server 206 of the power tool battery charger system 200 may utilize usage information from power tools, power tool battery chargers, and/or batteries similar to the power tool battery charger 202 and train a machine learning program, algorithm, or model using training examples from the received usage information from the power tools, power tool battery chargers, and/or batteries. The server 206 then transmits the trained machine learning program, algorithm or model to the machine learning controller 210 of the power tool battery charger 202 for execution during future operations of the power tool battery charger 202.

Accordingly, the static machine learning controller 210 includes a trained machine learning program, algorithm, or model provided, for example, at the time of manufacture. During future operations of the power tool battery charger 202, the static machine learning controller 210 analyzes new usage data from the power tool battery charger 202 and generates recommendations or actions based on the new usage data. As discussed above with respect to the machine learning controller 110, the static machine learning controller 210 has one or more specific tasks such as, for example, determining a maintenance procedure for a power tool battery pack. In other embodiments, the task of the static machine learning controller 210 may be different. In some embodiments, a user of the power tool battery charger 202 may select a task for the static machine learning controller 210 using, for example, a graphical user interface generated by the external device 104. The external device 104 may then transmit the target task for the static machine learning controller 210 to the server 206. The server 206 then transmits a trained machine learning program, algorithm, or model, trained for the target task, to the static machine learning controller 210. Based on the estimations or classifications from the static machine learning controller 210, the power tool battery charger 202 may change its operation, adjust one of the operating modes of the power tool battery charger 202, and/or adjust a different aspect of the power tool battery charger 202. In some embodiments, the power tool battery charger 202 may include more than one static machine learning controller 210, each having a different target task.

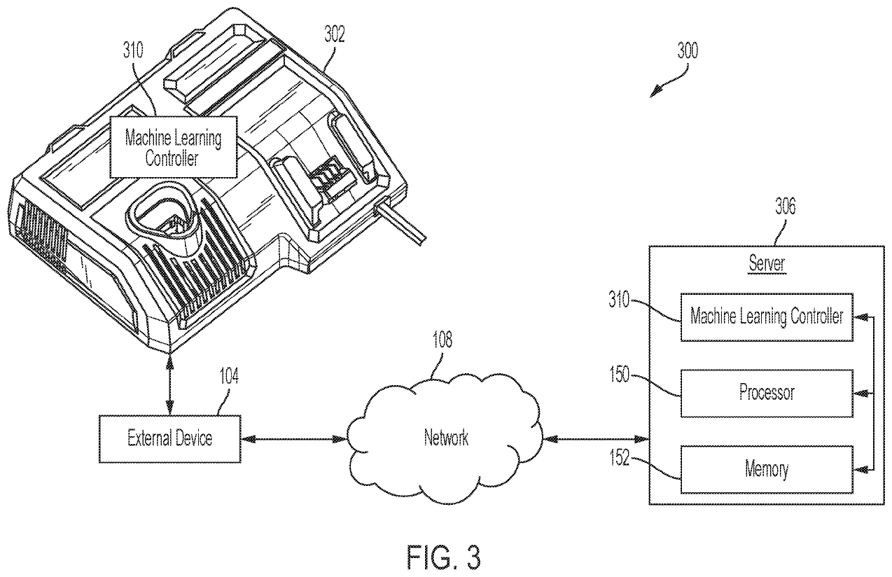

FIG. 3 illustrates a third power tool battery charger system 300 in accordance with an embodiment. The third power tool battery charger system 300 also includes a power tool battery charger 302, an external device 104, a server 306, and a network 108. The power tool battery charger 302 is similar to the power tool battery chargers 102, 202 described above and includes similar sensors that monitor various types of usage information of the power tool battery charger 302 such as, the usage information described above with respect to FIG. 1. The power tool battery charger 302 of the third power tool battery charger system 300, however, includes an adjustable machine learning controller 310 instead of the static machine learning controller 220 of the second power tool battery charger 202. In the illustrated embodiment, the adjustable machine learning controller 310 of the power tool battery charger 302 receives the machine learning program, algorithm, or model from the server 306 over the network 108. Unlike the static machine learning controller 220 of the second power tool battery charger 202, the server 306 may transmit updated versions of the machine learning program, algorithm, or model to the adjustable machine learning controller 310 to replace previous versions.

The power tool battery charger 302 of the third power tool battery charger system 300 transmits feedback to the server 306 (via, for example, the external device 104) regarding the operation of the adjustable machine learning controller 310. The power tool battery charger 302, for example, may transmit an indication to the server 306 regarding the number of operations that were incorrectly classified by the adjustable machine learning controller 310. The server 306 receives the feedback from the power tool battery charger 302, updates the machine learning program, algorithm, or model, and provides the updated program to the adjustable machine learning controller 310 to reduce the number of operations that are incorrectly classified. Thus, the server 306 updates or re-trains the adjustable machine learning controller 310 in view of the feedback received from the power tool battery charger 302. In some embodiments, the server 306 also uses feedback received from similar power tools and/or batteries to adjust the adjustable machine learning controller 310. In some embodiments, the server 306 updates the adjustable machine learning controller 310 periodically (e.g., every month). In other embodiments, the server 306 updates the adjustable machine learning controller 310 when the server 306 receives a predetermined number of feedback indications (e.g., after the server 306 receives two feedback indications). The feedback indications may be positive (e.g., indicating that the adjustable machine learning controller 310 correctly classified a condition, event, operation, or combination thereof), or the feedback may be negative (e.g., indicating that the adjustable machine learning controller 310 incorrectly classified a condition, event, operation, or combination thereof).

In some embodiments, the server 306 also utilizes new usage data received from the power tool battery charger 302 and batteries or power tools to update the adjustable machine learning controller 310. For example, the server 306 may periodically re-train (or adjust the training of) the adjustable machine learning controller 310 based on the newly received usage data. The server 306 then transmits an updated version of the adjustable machine learning controller 310 to the power tool battery charger 302.

When the power tool battery charger 302 receives the updated version of the adjustable machine learning controller 310 (e.g., when an updated machine learning program is provided to and stored on the machine learning controller 310), the power tool battery charger 302 replaces the current version of the adjustable machine learning controller 310 with the updated version. In some embodiments, the power tool battery charger 302 is equipped with a first version of the adjustable machine learning controller 310 during manufacturing. In such embodiments, the user of the power tool battery charger 302 may request newer versions of the adjustable machine learning controller 310. In some embodiments, the user may select a frequency with which the adjustable machine learning controller 310 is transmitted to the power tool battery charger 302.

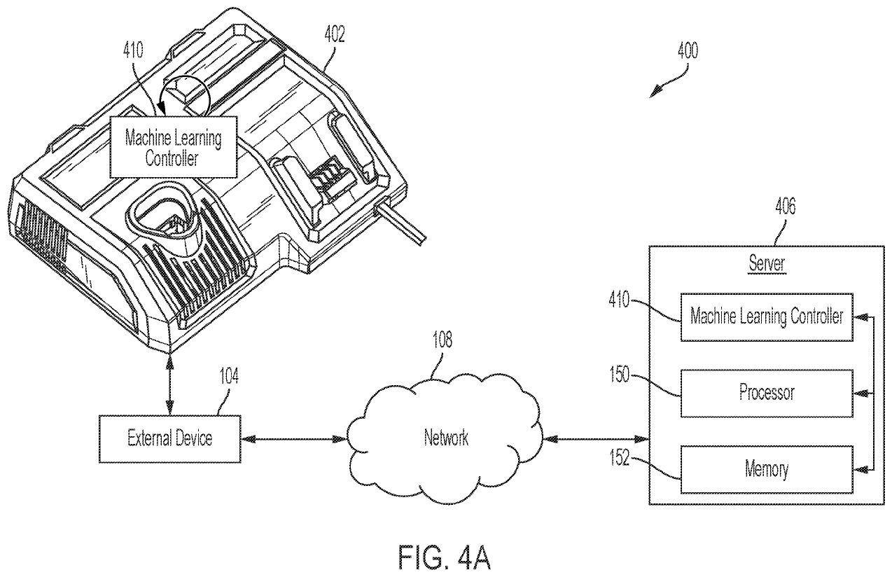

FIG. 4A illustrates a fourth power tool battery charger system 400 in accordance with an embodiment. The fourth power tool battery charger system 400 includes a power tool battery charger 402, an external device 104, a server 406, and a network 108. The power tool battery charger 402 includes a self-updating machine learning controller 410. The self-updating machine learning controller 410 is first loaded on the power tool battery charger 402 during, for example, manufacturing. In other words, the charger 402 receives a trained or partially trained machine learning program, algorithm, or model to be executed by a processor of the charger 402. The self-updating machine learning controller 410 updates itself. In other words, the self-updating machine learning controller 410 receives new usage information from the sensors in the power tool battery charger 402, feedback information indicating desired changes to operational parameters, feedback information indicating whether the classification made by the machine learning controller 410 is incorrect, or a combination thereof. The self-updating machine learning controller 410 then uses the received information to re-train the self-updating machine learning controller 410.

In some embodiments, the power tool battery charger 402 re-trains the self-updating machine learning controller 410 when the power tool battery charger 402 is not in operation. For example, the power tool battery charger 402 may detect when a battery is not connected to the power tool battery charger 402, when a battery is connected to the power tool battery charger 402, but fully charged, when the power tool battery charger 402 has not been operated for a predetermined time period, or the like, and start a re-training process of the self-updating machine learning controller 410 while the power tool battery charger 402 remains non-operational.

Training the self-updating machine learning controller 410 while the power tool battery charger 402 is not operating allows more processing power to be used in the re-training process instead of competing for computing resources typically used to operate the power tool battery charger 402. Additionally or alternatively, the power tool battery charger 402 may also re-train the self-updating machine learning controller 410 when the power tool battery charger 402 is in a particular operational mode or another operational condition is met. For instance, the power tool battery charger 402 may detect when a battery pack is put on the power tool battery charger 402 and start a re-training process of the self-updating machine learning controller 410 (e.g., based on power tool device data retrieved from the battery pack recently put on the power tool battery charger 402).

As shown in FIG. 4A, in some embodiments, the power tool battery charger 402 also communicates with the external device 104 and a server 406. For example, the external device 104 communicates with the power tool battery charger 402 as described above with respect to FIGS. 1-3. The external device 104 generates a graphical user interface to facilitate the adjustment of operational parameters of the power tool battery charger 402. The external device 104 may also bridge the communication between the power tool battery charger 402 and the server 406. For example, as described above with respect to FIG. 2, in some embodiments, the external device 104 receives a selection of a target task for the machine learning controller 410. The external device 104 may then request a corresponding machine learning program, algorithm, or model from the server 406 for transmitting to the power tool battery charger 402.

The power tool battery charger 402 also communicates with the server 406 (e.g., via the external device 104). In some embodiments, the server 406 may also re-train the self-updating machine learning controller 410, for example, as described above with respect to FIG. 3. The server 406 may use additional training examples from other similar power tool battery chargers, from one or more batteries, and/or one or more power tools. Using these additional training examples may provide greater variability and ultimately make the machine learning controller 410 more reliable. In some embodiments, the power tool battery charger 402 re-trains the self-updating machine learning controller 410 when the power tool battery charger 402 is not in operation, and the server 406 may re-train the machine learning controller 410 when the power tool battery charger 402 remains in operation (for example, while the power tool battery charger 402 is in operation during a scheduled re-training of the machine learning controller 410). Accordingly, in some embodiments, the self-updating machine learning controller 410 may be re-trained on the power tool battery charger 402, by the server 406, or with a combination thereof.

In some embodiments, the server 406 does not re-train the self-updating machine learning controller 410, but still exchanges information with the power tool battery charger 402. For example, the server 406 may provide other functionality for the power tool battery charger 402 such as, for example, transmitting information regarding various operating modes for the power tool battery charger 402.

Each of FIGS. 1-4A describes a power tool battery charger system 100, 200, 300, 400 in which a power tool battery charger 102, 202, 302, 402 communicates with a server 106, 206, 306, 406 and with an external device 104. As discussed above with respect to FIG. 1, the external device 104 may bridge communication between the power tool battery charger 102, 202, 302, 402 and the server 106, 206, 306, 406. That is, the power tool battery charger 102, 202, 302, 402 may communicate directly with the external device 104. The external device 104 may then forward the information received from the power tool battery charger 102, 202, 302, 402 to the server 106, 206, 306, 406. Similarly, the server 106, 206, 306, 406 may transmit information to the external device 104 to be forwarded to the power tool battery charger 102, 202, 302, 402. In such embodiments, the power tool battery charger 102, 202, 302, 402 may include a transceiver to communicate with the external device 104 via, for example, a short-range communication protocol such as Bluetooth® or Wi-Fi®. The external device 104 may include a short-range transceiver to communicate with the power tool battery charger 102, 202, 302, 402, and may also include a long-range transceiver to communicate with the server 106, 206, 306, 406. In some embodiments, a wired connection (via, for example, a USB cable) is provided between the external device 104 and the power tool battery charger 102, 202, 302, 402 to enable direct communication between the external device 104 and the power tool battery charger 102, 202, 302, 402. Providing the wired connection may provide a faster and more reliable communication method between the external device 104 and the power tool battery charger 102, 202, 302, 402.

The external device 104 may include, for example, a smartphone, a tablet computer, a cellular phone, a laptop computer, a smart watch, and the like. The server 106, 206, 306, 406 illustrated in FIGS. 1-4A includes at least a server processor 150, a server memory 152, and a transceiver to communicate with the power tool battery charger 102, 202, 302, 402 via the network 108. The server processor 420 receives usage data from the power tool battery charger 102, 202, 302, 402, stores the usage data in the server memory 152, and, in some embodiments, uses the received usage data for constructing, training, and/or adjusting the machine learning controller 110, 210, 310, 410. The term external system device may be used herein to refer to one or more of the external device 104 and the server 106, 206, 306, 406, as each are external to the power tool battery charger 102, 202, 302, 402. Further, in some embodiments, the external system device is a wireless hub, such as a beaconing device placed on a jobsite to monitor power tools, batteries, and/or power tool battery chargers; function as a gateway network device (e.g., providing Wi-Fi® network); or both. As described herein, the external system device includes at least an input/output unit (e.g., a wireless or wired transceiver) for communication, a memory storing instructions, and an electronic processor to execute instructions stored on the memory to carry out the functionality attributed to the external system device.

In some embodiments, the power tool battery charger 402 may not communicate with the external device 104 or the server 406. For example, FIG. 4B illustrates the power tool battery charger 402 with no connection to the external device 104 or the server 406. Rather, since the power tool battery charger 402 includes the self-updating machine learning controller 410, the power tool battery charger 402 can implement the machine learning controller 410, receive user feedback, usage data, and/or other operational data, and update the machine learning controller 410 without communicating with the external device 104 or the server 406.

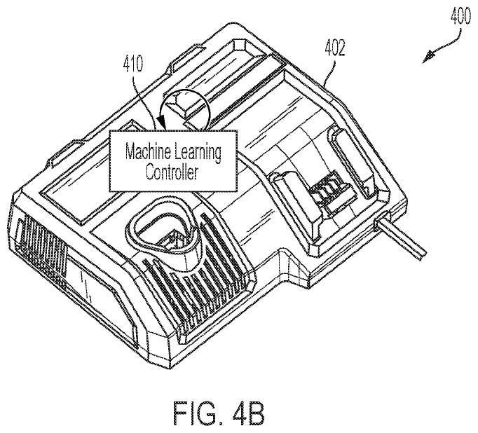

FIG. 5 illustrates a fifth power tool battery charger system 500 including a power tool battery charger 502 and an external device 504 in accordance with an embodiment. The external device 504 communicates with the power tool battery charger 502 using the various methods described above with respect to FIGS. 1-4A. In particular, the power tool battery charger 502 transmits usage data and/or operational data regarding the operation of the power tool battery charger 502 to the external device 504. The external device 504 generates a graphical user interface to facilitate the adjustment of operational parameters of the power tool battery charger 502 and to provide information regarding the operation of the power tool battery charger 502 to the user.

In the illustrated embodiment of FIG. 5, the external device 504 includes a machine learning controller 510. In some embodiments, the machine learning controller 510 is similar to the machine learning controller 110 of FIG. 1. In such embodiments, the machine learning controller 510 receives the usage information from the power tool battery charger 502 and generates recommendations for future operations of the power tool battery charger 502. The machine learning controller 510 may, in such embodiments, generate a set of parameters and/or updated thresholds recommended for the operation of the power tool battery charger 502 in particular modes. The external device 504 then transmits the updated set of parameters and/or updated thresholds to the power tool battery charger 502 for implementation.

In some embodiments, the machine learning controller 510 is similar to the machine learning controller 310 of FIG. 3. In such embodiments, the external device 504 may update the machine learning controller 510 based on, for example, feedback received from the power tool battery charger 502 and/or other operational data from the power tool battery charger 502. In such embodiments, the power tool battery charger 502 also includes a machine learning controller similar to, for example, the adjustable machine learning controller 310 of FIG. 3. The external device 504 can then modify and update the adjustable machine learning controller 510 and communicate the updates to the machine learning controller 510 to the power tool battery charger 502 for implementation. For example, the external device 504 can use the feedback from the user, or other usage or operational data, to retrain the machine learning controller 510, to continue training a machine learning controller 510 implementing a reinforcement learning control, or may, in some embodiments, use the feedback or data to adjust a switching rate on a recurrent neural network, for example.

In some embodiments, as discussed briefly above, the power tool battery charger 502 also includes a machine learning controller. The machine learning controller of the power tool battery charger 502 may be similar to, for example, the static machine learning controller 210 of FIG. 2, the adjustable machine learning controller 310 of FIG. 3 as described above, or the self-updating machine learning controller 410 of FIG. 4A.

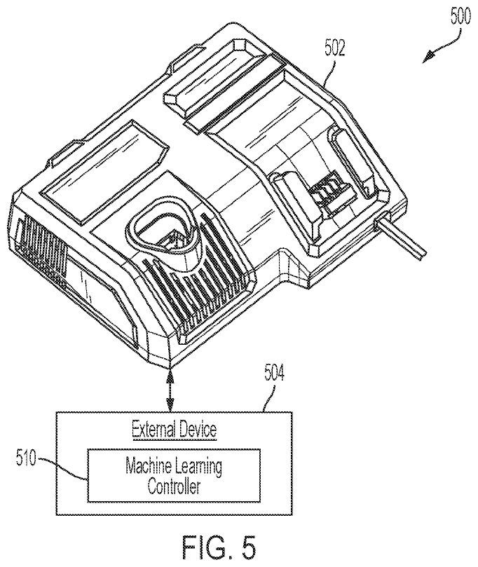

FIG. 6 illustrates an example battery pack 630 in accordance with an embodiment. The battery pack 630 includes a machine learning controller 610. Although not illustrated, the battery pack 630 may, in some embodiments, communicate with the external device 104, a server, or a combination thereof, through, for example, a network. Additionally or alternatively, the battery pack 630 may communicate with a power tool battery charger, such as a power tool battery charger to which the battery pack 630 is connected, or may communicate with a power tool attached to the battery pack 630. The external device 104 and the server may be similar to the external device 104 and server 106, 206, 306, 406 described above with respect to FIGS. 1-4A. The machine learning controller 610 of the battery pack 630 may be similar to any of the machine learning controllers 210, 310, 410 described above. In one embodiment, the machine learning controller 610 controls operation of the battery pack 630. For example, the machine learning controller 610 may help identify different battery conditions that may be detrimental to the battery pack 630 and may automatically change (e.g., increase or decrease) the amount of current provided by or to the battery pack 630, and/or may change some of the thresholds that regulate the operation of the battery pack 630. For example, the battery pack 630 may, from instructions of the machine learning controller 610, reduce power to inhibit overheating of the battery cells. In some embodiments, the battery pack 630 communicates with a power tool battery charger (e.g., similar to the power tool battery charger 102, 202, 302, 402, 502) and the machine learning controller 610 controls at least some aspects and/or operations of the power tool battery charger. For example, the battery pack 630 may receive usage data (e.g., sensor data) from the power tool battery charger, a power tool, user feedback, or other data source and generate outputs to control the operation of the power tool battery charger. The battery pack 630 may then transmit the control outputs to the electronic processor of the power tool battery charger.

Each of FIGS. 1-6 illustrate various embodiments in which different types of machine learning controllers 110, 210, 310, 410, 510, 610 are used in conjunction with the power tool battery charger 102, 202, 302, 402, 502 or battery pack 630. In some embodiments, each power tool battery charger 102, 202, 302, 402, 502 or battery pack 630 may include more than one machine learning controller 110, 210, 310, 410, 510, 610, and each machine learning controller 110, 210, 310, 410, 510, 610 may be of a different type. For example, a power tool battery charger 102, 202, 302, 402, 502 or battery pack 630 may include a static machine learning controller 210 as described with respect to FIG. 2 and may also include a self-updating machine learning controller 410 as described with respect to FIG. 4A. In another example, the power tool battery charger 102, 202, 302, 402, 502 or battery pack 630 may include a static machine learning controller 210. The static machine learning controller 210 may be subsequently removed and replaced by, for example, an adjustable machine learning controller 310. In other words, the same power tool battery charger or battery pack may include any of the machine learning controllers 110, 210, 310, 410, 510, 610 described above with respect to FIGS. 1-6. Additionally, a machine learning controller 710, shown in FIGS. 7A and 7C and described in further detail below, is an example controller that may be used as one or more of the machine learning controllers 110, 210, 310, 410, 510, 610.

FIG. 7A is a block diagram of a charging system 700 for a power tool battery pack in accordance with an embodiment. The charging system 700 includes a power tool battery pack charger 702, an external device 704, a network 708, and a server 706. As discussed above with respect to FIGS. 1-4A and 5, the power tool battery pack charger 702 may communicate with the external device 704, the network 708, and/or the server 706, for example, to transmit at least a portion of the usage information for the power tool battery charger 702, to receive configuration information for the power tool battery charger 702, or a combination thereof. Accordingly, as discussed above with respect to FIGS. 1-4A and 5, the power tool battery charger 702, external device 704, and the server 706 may include a communication system or device such as, for example, a transceiver.

The external device 704 may include, for example, a smartphone, a tablet computer, a cellular phone, a laptop computer, a smart watch, and the like. The external device 704 may include a controller 760 having a processor 762 and a memory 764, and a display 766. In some embodiments, the controller 760 of the external device 704 may be a machine learning controller, for example, similar to the machine learning controller 510 described above with respect to FIG. 5. Network 708 may be long-range wireless network, such as the Internet, a local area network (“LAN”), a wide area network (“WAN”), or a combination thereof. In other embodiments, the network 708 may be a short-range wireless communications network, and in yet other embodiments, the network 708 may be a wired network using, for example, one or more USB or Ethernet cables. In some embodiments, the server 706 may include a controller 754 having a processor 750 and a memory 752. In some embodiments, the control 754 may be a machine learning controller, for example, similar to the machine learning controllers 110, 310, and 410 as described above with respect to FIGS. 1, 3, and 4A.

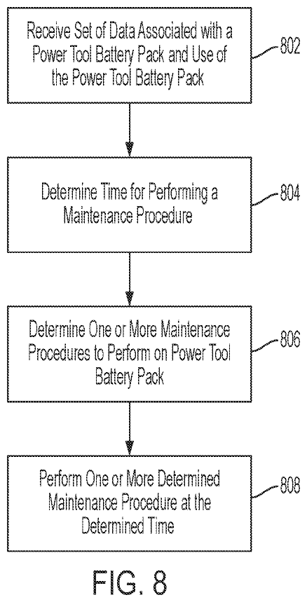

The power tool battery charger 702 may be configured to receive and provide charging current to at least one power tool battery pack 732. The power tool battery charger 702 may include a battery pack interface 712, an electronic controller 714, a communication device 718, a display 720 and a user interface 722. In some embodiments, power tool battery charger 702 may also include sensor(s) (e.g., voltage sensors or voltage sensing circuits, current sensors or current sensing circuits, temperature sensors or temperature sensing circuits, inertial sensors or inertial sensing circuits (e.g., accelerometers, gyroscopes, manometers), or the like), and other elements that are not shown in FIG. 7 to simplify the illustration. The electronic controller 714, may be configured to perform one or more of the methods described herein. For example, the electronic controller 714 may be configured to implement the various methods described herein with respect to FIGS. 8-10.

The battery pack interface 712 of the power tool battery charger 702 may be configured to selectively receive and interface with a power tool battery pack 732. The battery pack interface 712 may include one or more charging ports (e.g., for charging one or more battery packs). Each charging port of the battery pack interface 712 can include one or more power terminals and, in some cases, one or more communication terminals that interface with respective power and/or communication terminals of the power tool battery pack 732. For example, a charger interface 734 of the battery pack 732 may include power and/or communication terminals to interface with the respective power and/or communication terminals of the battery pack interface 712. In some examples, one or more of the charging ports are wireless charging interfaces that allow wireless power and/or data transfer to a wireless interface of the power tool battery pack 732. The power tool battery pack 732 may include one or more battery cells of various chemistries, such as lithium-ion (Li-Ion), nickel cadmium (Ni-Cad), and the like. The power tool battery pack 732 and/or the power tool battery pack charger 702 may further include a mechanical interface to prevent unintentional detachment. The power tool battery pack 732 may further include a display 738 and a controller 736 (pack controller) having a processor 740 and a memory 742. The controller 736 may be configured similarly to the electronic controller 714 of the power tool battery charger 702. The pack controller 736 may be, for example, configured to regulate charging and discharging of the battery cells, and/or to communicate with the electronic controller 714. In some embodiments, the pack controller 736 may include a machine learning controller (e.g., controller 736 may be implemented as or include a machine learning controller) similar to, for example, the machine learning controller described above with respect to FIG. 6. In some embodiments, the machine learning controller may control operation of the battery pack 732. In some embodiments, as discussed above, the power tool battery pack 732 further includes a transceiver (not shown) coupled to the pack controller 736. Accordingly, the pack controller 736, and thus the power tool battery pack 732, may be configured to communicate with other devices. Although not illustrated, the battery pack 732 may, in some embodiments, communicate with the external device 704, the server 706 or a combination thereof, through, for example, the network 708 or a direct connection. Additionally or alternatively, the battery pack 732 may communicate with the power tool battery charger 702 to which the battery pack 732 is connected, or may communicate with a power tool (not shown) attached to the battery pack.

The power tool battery charger 702 may receive power from an external power source through a power interface, which may be an AC power interface, a DC power interface, or both an AC and DC power interface. In some embodiments, the external power source includes an AC power source. In such embodiments, the power interface may include an AC power cord that is connectable to, for example, an AC outlet. In some embodiments, the external power source includes a DC power source. In such embodiments, the power interface may include a DC port, such as a USB® port, that is connectable to a USB® cable to provide power to the charger. In other examples, another DC port is employed. The external power source may take various forms, such as an AC utility grid (via an AC wall outlet), solar panel(s), a battery power bank, an AC or DC output of a vehicle, and AC or DC output of an engine-generator, and the like. The power interface is coupled to the controller 714 and other components of the charger. The power interface may condition power received from an external power source (e.g., rectify, filter, etc.) and transmit power received from the external power source to the controller 714 as well as other elements of the power tool battery charger 702. For example, in the case of being coupled to an AC external power source, the power interface may include an AC/DC rectifier (and, optionally, a DC/DC converter) to convert the received AC power to DC power level appropriate for powering the components of the charger 702.

The electronic controller 714 of the power tool battery charger 702 can include a machine learning controller 710 and a charger controller 716. The machine learning controller 710 may be coupled to the charger controller 716, and in some embodiments may be selectively coupled, e.g., using a switch (not shown). In the embodiment of FIG. 7A, the machine learning controller 710 is positioned on a separate printed circuit board (“PCB”) as the charger controller 716. The PCB of the charger controller 716 and the machine learning controller 710 may be coupled with, for example, wires or cables to enable the charger controller 716 to control the power tool battery charger 702 based on the outputs and determinations from the machine learning controller 710.

As shown in FIG. 7B, the charger controller 716 can include a processor 728 and a memory 730. Memory 730 may include read-only memory (ROM), random access memory (RAM), other non-transitory computer-readable media, or a combination thereof. The memory 730 may also include instructions for processor 728 of the controller 716 to execute, e.g., to implement the functions of the charger controller 716 described herein. The processor 728 may also be configured to communicate with the memory 730 to store data and retrieve stored data. In some embodiments, the machine learning controller 710 may be stored in the memory 730 of the charger controller 716 and may be implemented by the charger controller 716. In yet other embodiments, the machine learning controller 710 is implemented as a separate processing unit in the electronic controller 714, but is positioned on the same PCB as the charger controller 716. Embodiments with the machine learning controller 710 implemented as a separate processing unit from the charger controller 716, whether on the same or different PCBs, allows selecting a processing unit to implement each of the machine learning controller 710 and the charger controller 716 that has its capabilities (e.g., processing power and memory capacity) tailored to the particular demands of each unit. Such tailoring can reduce costs and improve efficiencies of the power tools. In some embodiments, as illustrated in FIG. 5, for example, the external device 104 includes the machine learning controller 710 and the power tool battery charger 702 communicates with the external device 104 to receive the estimations or classifications from the machine learning controller 710.

In some embodiments, the machine learning controller 710 is implemented in a plug-in chip or controller that is easily selectively added to the power tool battery charger 702 (e.g., at the time of manufacture or by an end-user). For example, the machine learning controller 710 may include a plug-in chip that is received within a cavity of the power tool battery charger 702 and connects to the charger controller 716. For example, in some embodiments, the power tool battery charger 702 includes a lockable compartment including electrical contacts that is configured to receive and electrically connect to the plug-in machine learning controller 710. The electrical contacts enable bidirectional communication between the plug-in machine learning controller 710 and the electronic controller 720, and enable the plug-in machine learning controller 710 to receive power from the power tool battery charger 702.

As described above with respect to FIGS. 1-6, the machine learning controller 710 includes a trained machine learning controller that utilizes previously collected data to analyze and classify new data from the power tool battery charger 702, one or more battery packs 732, and/or one or more power tools (not shown). As explained in more detail below, the machine learning controller 710 can determine when to perform a maintenance procedure on a power tool battery pack, determine a maintenance procedure to perform on a power tool battery pack, determine whether to perform a maintenance procedure on a power tool battery, identify maintenance procedures to perform on a power tool battery pack, determine recommendations regarding a non-use mode for a power tool battery pack, and so on.

In one embodiment, when the machine learning controller 710 is activated, the charger controller 716 controls the operation of the power tool battery charger 702 (e.g., charging or discharging a power tool battery pack 732 connected to the power tool battery charger 702, performing cell balancing of a power tool battery pack 732) based on the determinations from the machine learning controller 710. Otherwise, if the machine learning controller 710 is deactivated or disabled, the machine learning controller 710 does not affect the operation of power tool battery charger 702. In some embodiments, the machine learning controller 710 may operate in the background without affecting the operation of the power tool battery charger 702. For example, the machine learning controller 710 may continue to generate output, but the charger controller 716 does not change the operation of the power tool battery charger 702 based on the determinations and/or outputs from the machine leaning controller 710.

In some embodiments, the power tool battery charger 702 may implement an artificial intelligence controller instead of, or in addition to, the machine learning controller 710. The artificial intelligence controller implements one or more AI programs, algorithms, or models. In some embodiments, the AI controller is configured to implement the one or more AI programs, algorithms, or models such as an expert system, a rules engine, a symbolic logic, one or more knowledge graphs, and so on. In some embodiments, the AI controller is integrated into and implemented by the electronic controller 714 (e.g., the electronic controller 714 may be referred to as an AI controller). In some embodiments, the AI controller is a separate controller from the electronic controller 714 and includes an electronic processor and memory, similar to the machine learning controller 710 as illustrated in FIG. 7C, which is described further below.

In some embodiments, the power tool battery charger 702 may include one or more inputs, for example, a user interface 722 and a communication device 718. In some embodiments, the user interface 722 is coupled to the electronic controller 714 and may be configured to receive data (e.g., selection of a maintenance procedure or a non-use mode for a power tool battery pack 732) from a user that may then be provided to electronic controller 714. In some embodiments, the user interface 722 is a graphical user interface. The user interface 722 may include or be coupled to a display 720. In some embodiments, the user interface 722 may include manually manipulateable input devices, such as buttons, knobs, levers, touch a touch screen, etc. Accordingly, the user interface 722 may, for example, allow a user to push a button, turn a knob, etc. to select a maintenance procedure or non-use mode. The communications device 718 may include, for example, a radio transceiver and antenna, a memory, and an electronic processor. In some embodiments, the communication device 718 can further include a GNSS receiver configured to receive signals from GNSS satellites, land-based transmitters, etc. In some embodiments, the display 720 may include, for example, LEDs or a display screen and may generate various signals. In some embodiments, the power tool battery charger 702 does not include display 720. In some embodiments, the power tool battery charger 702 communicates with the external device 704, and the external device 704 generates a graphical user interface (e.g., on display 766) that conveys information to the user without the need for display 720 on the power tool battery charger 702 itself

As shown in FIG. 7C, the machine learning controller 710 can include an electronic processor 724 and a memory 726. Memory 726 may include read-only memory (ROM), random access memory (RAM), other non-transitory computer-readable media, or a combination thereof. The memory 726 may also include instructions for processor 724 of the controller 710 to execute. The processor 724 may be configured to communicate with the memory 726 to store data and retrieve stored data. In some embodiments, the memory 726 stores a machine learning control 744, which may also be referred to as machine learning control instructions. The machine learning control 744 may include a trained machine learning program, algorithm, or model, as described above with respect to FIGS. 1-6. For example, reference to storing, transmitting, receiving, executing, or updating of a machine learning controller herein (e.g., machine learning controllers 110, 210, 310, etc.) refers, at least in some examples, to a processor of the machine learning controller or the device having the machine learning controller storing, transmitting, receiving, executing, or updating machine learning control instructions, such as machine learning control instructions 744. In some embodiments, the electronic processor 724 may include a graphics processing unit.

As discussed above with respect to FIG. 1, the machine learning control 744 may be constructed, trained, and/or operated by the server 106, 706. In other embodiments, the machine learning control 744 may be constructed and/or trained by the server 106, 706, but implemented by the power tool battery charger 702 (similar to FIGS. 2 and 3), and in yet other embodiments, the power tool battery charger 702 (e.g., the charger controller 716, electronic processor 724, or a combination thereof) constructs, trains, and/or implements the machine learning control 744 (similar to FIG. 4B). The machine learning controller 710 may be a static machine learning controller similar to the static machine leaning controller 210 of the second power tool battery charger 202 described above, an adjustable machine learning controller similar to the adjustable machine learning controller 310 of the third power tool battery charger 302 described above, or a self-updating machine learning controller similar to the self-updating machine learning controller 410 of the fourth power tool battery charger 402 described above. In some embodiments, the machine learning controller 710 includes multiple machine learning controllers similar to one or more of the machine learning controllers 210, 310, and/or 410 (e.g., one or more static machine learning controllers, one or more adjustable machine learning controllers, and/or one or more self-updating machine learning controllers). Each such machine learning controller making up the machine learning controller 710 may be or can include a different machine learning program, algorithm, or model and, therefore, may be configured to execute a different task or function.

Although the power tool battery charger 702 (shown in FIG. 7A) is described as being in communication with the external device 704 or with a server 706, in some embodiments, the power tool battery charger 702 is self-contained or closed, in terms of machine learning, and does not need to communicate with the external device 704, the server 706 or any other external system device to perform the functionality of the machine learning controller 710.

As mentioned above, the power tool battery charger 702 (e.g., electronic controller 714) may be configured to determine when to perform a maintenance procedure on a power tool battery pack 732, to determine a maintenance procedure to perform on a power tool battery pack 732, and to determine whether to perform a maintenance procedure on a power tool battery pack 732. FIG. 8 illustrates a method for determining a maintenance procedure for a power tool battery pack in accordance with an embodiment. The process illustrated in FIG. 8 is described below as being carried out by the power tool battery charger 702 according to the electronic controller 714, the machine learning controller 710, and/or a charger controller 716 as illustrated in FIGS. 7A-C or alternatively according to an artificial intelligence controller as described above. However, in some embodiments, the process is implemented by another power tool battery charger having additional, fewer, and/or alternative components, or integrated into another device (e.g., a portable power supply or inverter). In some embodiments, a controller of a portable power supply or inverter (rather than a charger), which may be similar to one of the controllers described herein, implements the process of FIG. 8. Additionally, although the blocks of the process are illustrated in a particular order, in some embodiments, one or more of the blocks may be executed partially or entirely in parallel, may be executed in a different order than illustrated in FIG. 8, or may be bypassed.

In block 802, a power tool battery pack charger 702 receives a set of data associated with a power tool battery pack 732 and use of the power tool battery pack 732. The set of data may include, for example, power tool device data which, as mentioned above, may include usage data, maintenance data, sensor data, environmental data, operator data, location data, user settings data, among other data. Usage data may include usage data for a power tool battery charger, a power tool battery pack, a power tool, or other devices connected to a power tool device network, such as wireless communication devices, control hubs, access points, and/or peripheral devices (e.g., smartphones, tablet computers, laptop computers, portable music players, and the like). The set of data may be received from various sources, as described herein. For example, the set of data may be received by the electronic controller 714 of the charger 702 from the power tool battery pack 732 (e.g., from a memory of the battery pack 732 populated by the battery pack 732 during use of the pack), from a memory for the charger 702 (e.g., the memory 730 or the memory 726), from the external device 704, from the server 706, or a combination thereof. The source of the particular data making up the set of data may be provided by the device that collects or generates such data. For example, usage data for the charger 702 may be retrieved from a memory of the charger 702, while usage data for the power tool battery pack may be provided to the charger 702 from the power tool battery pack 732. Data of the set of data that is provided to the charger 702 from another device in block 802 may be communicated via one or more of the wired or wireless connections and communication capabilities of the charger 702, as described herein (e.g., with respect to FIG. 7A).

Usage data for a power tool battery charger 702 may include operation time of the power tool battery charger 702 (e.g., how long the power tool battery charger 702 is used in each session, the amount of time between sessions of power tool battery charger 702 usage, and the like), times of day when battery packs 732 are being put on and/or taken off of the power tool battery charger 702, unique identifiers of battery packs 732 being put on and/or taken off of the power tool battery charger 702, specific hours when work is being performed on a jobsite (or being performed more or less frequently on the jobsite), days of the week when work is being performed on a jobsite (or being performed more or less frequently on the jobsite), charging patterns, and the like. In some embodiments, usage data may include data indicating the order in which batteries are put on a power tool battery charger 702 with multiple charging ports, or on power tool battery chargers 702 in a network of connected (e.g., wired or wirelessly) power tool battery chargers.

Usage data for a battery pack 732 may include operation time of the battery pack 732 (e.g., how long the battery pack 732 is used in each session, the amount of time between sessions of battery pack usage, and the like), the types of power tool(s) on which the battery pack 732 is being used, the frequency with which the battery pack 732 is being used, the frequency with which the battery pack 732 is being used with a particular power tool or power tool type, the frequency with which the battery pack 732 is charged on a particular power tool battery charger 702 or power tool battery charger type, the current charge capacity of the battery pack (e.g., the state or level of charge of the battery pack), ideal rate for draining energy, the number of charge cycles the battery pack 732 has gone through, characteristics of the charge cycles (e.g., peak temperature, loading information like average current, and the like), the estimated remaining useful life of the battery pack 732, information regarding if and when a power tool battery pack 732 (by itself or when attached to a power tool) was dropped, and the like. In some embodiments, usage data may include data indicating the usage of a particular battery.

Usage data for a power tool may include the operation time of the power tool (e.g., how long the power tool is used in each session, the amount of time between sessions of power tool usage, and the like); whether a particular battery pack 732 is used with the power tool and/or the frequency with which the particular battery pack 732 is used with the power tool; whether a particular battery pack type is used with the power tool and/or the frequency with which the particular battery pack 732 is used with the power tool; the type of power tool applications the power tool is frequently used for; information regarding changes in bits, blades, or other accessory devices for the power tool; and the like.

Maintenance data may include maintenance data for a power tool battery charger, a power tool battery, and/or a power tool. For example, maintenance data may include a log of prior maintenance (e.g., the time (e.g., number of days) since the last calibration or near full discharge), suggestions for future maintenance, and the like.

Sensor data may include sensor data collected using one or more sensors (e.g., voltage sensor, a current sensor, a temperature sensor, an inertial sensor) of the power tool battery charger 702, battery pack 732, and/or power tool. For example, the sensor data may include voltage sensor data indicating a measured voltage associated with the power tool battery charger 702, battery pack 732, and/or power tool. For example, such a measured voltage may include a voltage measured across positive and negative power terminals of a power tool battery charger, battery pack, and/or power tool. Likewise, the sensor data may include current sensor data indicating a measured current associated with the power tool battery charger 702, battery pack 732, and/or power tool. For example, such a measured current may include a charging current provided from a power tool battery charger 702 and/or received by a battery pack 732 (e.g., at power terminals of the power tool battery charger or battery pack). Additionally, such a measured current may include a discharge current provided from a battery pack 732 and/or received by a power tool (e.g., at power terminals of the battery pack or power tool). Additionally or alternatively, the sensor data may include temperature sensor data that indicate an internal and/or operating temperature of the power tool battery charger 702, battery pack 732, and/or power tool. In some embodiments, the sensor data can include inertial sensor data, such as accelerometer data, gyroscope data, and/or magnetometer data. These inertial sensor data can indicate a motion of the power tool battery charger 702, battery pack 732, and/or power tool, and can be processed by an electronic controller to determine a force, angular rate, and/or orientation of the power tool battery charger 702, battery pack 732, and/or power tool.

Environmental data may include data indicating a characteristic or aspect of the environment in which the power tool battery charger 702, battery pack 732, and/or power tool is located. For example, environmental data can include data associated with the weather, a temperature (e.g., external temperature) of the surrounding environment, the humidity of the surrounding environment, and the like.

Operator data may include data indicating an operator and/or owner of a power tool battery charger, a battery pack, a power tool, and the like. For example, operator data may include an operator identifier (ID), an owner ID, or both.

Location data may include data indicating a location of a power tool battery charger 702, a battery pack 732, a power tool, and the like. In some embodiments, the location data may indicate a physical location of the power tool battery charger 702, the battery pack 732, and/or power tool. For example, the physical location may be represented using geospatial coordinates, such as those determined via GNSS or the like. As another example, the physical location may be represented as a jobsite location (e.g., an address, an identification of a jobsite location) and may include a location within a jobsite (e.g., a particular floor in a skyscraper or other building under construction). In some other embodiments, the location data may indicate a location of the power tool battery charger 702, the battery pack 732, and/or power tool for inventory management and tracking.

User settings data may include data indicating a user setting or preference. The user setting or preference may indicate a time or time range in which a user prefers that maintenance operations are performed or certain types of maintenance operations are performed.

In block 804, the received set of data is used to determine a time for performing a maintenance procedure on the power tool battery pack 732. The received set of data may be analyzed using, for example, the electronic controller 714 of the power tool battery pack charger 702. In some embodiments, the set of data may be analyzed using a machine learning controller 710 included in the electronic controller 714. In some embodiments, the set of data may be analyzed using the charger controller 716 included in the electronic controller 714. For example, based on received data associated with a battery pack 732 connected to the power tool battery charger 702 including, but not limited to, a unique identifier of the battery packs 732 being put on the power tool battery charger 702, operation time of the battery pack 732, the frequency with which the battery pack 732 is charged on a particular power tool battery charger 702 or power tool battery charger type, specific hours when work is being performed on a jobsite (or being performed more or less frequently on the jobsite), days of the week when work is being performed on a jobsite (or being performed more or less frequently on the jobsite), and the like, the electronic controller 714 (e.g., the machine learning controller 710 and/or charger controller 716) can determine or predict when the battery pack 732 is likely not to be in use (e.g., end of the day, weekend) and determine a time for performing a maintenance procedure based on when the battery pack is expected not to be in use (i.e., a time or times that do not coincide with expected use of the battery pack 732). For example, the machine learning controller 710 may include the machine learning control 744 (see FIG. 7B) that has been trained, using techniques described above, with training data including examples of the set of data (e.g., of the same type received in block 802) labeled with an indication of a time at which maintenance should occur. In block 804, the processor 724 of the machine learning controller 710 may then execute the (trained) machine learning control 744 to receive and process the set of data (received in block 802) to determine the time for performing the maintenance procedure. In some embodiments, the set of data on which the determination of the time is made includes user-entered data, such as a request, scheduled time, prioritization, snooze (delay), or configuration for a maintenance procedure using, for example, external device 704 or the user interface 722 of the power tool battery charger 702.

In block 806, the received set of data is used to determine one or more maintenance procedures to perform on the power tool battery pack 732. In some embodiments, the determination of the one or more maintenance procedure can include whether to perform the identified maintenance procedure(s) at the time identified at block 804 (e.g., would the maintenance procedure be useful and ideal to do at the determine time). The received data may be analyzed using, for example, the electronic controller 714 of the power tool battery pack charger 702. In some embodiments, the set of data may be analyzed using a machine learning controller 710 included in the electronic controller 714. In some embodiments, the set of data may be analyzed using the charger controller 716 included in the electronic controller 714. In some embodiments, the maintenance procedures may include a capacity check of the battery pack 732 (e.g., determining a maximum capacity or true state of charge of the battery pack 732), cell balancing of the battery pack 732, cooling of the battery pack 732, heating of the battery pack 732 and the like.

In one example, data including, but not limited to, a unique identifier of the battery pack 732 being put on the power tool battery charger 702, and a level of charge of the battery pack 732 when it is put in the power tool battery charger 702, may be used to determine if a capacity check should be performed (e.g., whether the battery pack 732 should be cycled) on the battery pack 732. For example, a nearly fully discharged battery pack 732 may be a better candidate for a capacity check. A capacity check may include a process of fully discharging and then charging the battery pack 732. Other data, such as data indicating when the last calibration or near full discharge was done (e.g., number of days since the last recalibration) and data indicating battery pack usage information since the last recalibration (e.g., number of cycles, characteristics of the cycles, and the like) can be used to help determine if a capacity check is needed. For example, if a battery pack 732 was recently put on a power tool battery charger 702 depleted and that battery pack 732 went through a full charge (and, hence, could be, and was, recalibrated), there might not be a need or desire to recalibrate the battery pack 732.

In another example, data including, but not limited to, a unique identifier of the battery pack 732 being put on the power tool battery charger 702, an indication of a need for the battery pack 732 at a jobsite (e.g., based on time of day, nearby battery packs), information regarding if and when a power tool battery pack 732 (by itself or when attached to a power tool) was dropped, weather (e.g., precipitation), the types of power tool(s) on which the battery pack 732 is being used (e.g., outdoor tools, indoor tools, tools that work with metal objects, that present a risk of metal debris getting in the battery pack 732, pumps and/or fans that present a risk of water getting into the battery pack 732)), ambient temperature, and geography (e.g., near coastal regions may risk the introduction of salt) may be used to determine if cell balancing should be performed on the battery pack 732. In some embodiments, the electronic controller 714 may be configured to prioritize charging the battery pack 732 to a near full charge before doing cell balancing because cell balancing may only require a small amount of discharging. Other data such as data indicating when the last calibration or near full discharge was done (e.g., number of days since the last recalibration) and data indicating battery pack usage information since the last recalibration (e.g., number of cycles, characteristics of the cycles, and the like) can be used to help determine if cell balancing is needed.

In yet another example, the maintenance procedure may be heating or cooling a battery pack 732 to, for example, optimize or increase the battery packs 732 readiness for use. A battery pack 732 that is too cold (e.g., below a threshold) or too hot (e.g., above a threshold), may perform in a substandard manner during charging and/or discharging operations. Accordingly, in some embodiments, the maintenance produced may be performed to pre-emptively raise the temperature of the battery pack 732 before use (e.g., from a cold temperature to a desired temperature), or to pre-emptively decrease the temperature of the battery pack 732 before use (e.g., from a hot temperature to a desired temperature). Charging naturally causes heat generation and based on the predicted time of expected use for a battery pack 732, the electronic controller 714 may determine that a final bit of charging should be performed right before the expected time of use to heat the battery pack 732 to a desired temperature. Performing operations such as, for example discharging (draining), and cell balancing on a battery pack 732 can also cause the generation of heat, and can be performed at a desired time or in certain conditions to heat the heat the battery pack 732 to a desired temperature. For example, if the external temperature of the environment in which the battery pack 732 is located and/or will be used is cold (e.g., determined by the controller to be below a predetermined threshold temperature), the electronic controller may determine that cell balancing should be performed to preheat the battery pack 732 when use of the battery pack 732 is expected shortly.

In some embodiments, the electronic controller 714 (e.g., the charger controller 716) may activate a heating function of the charger or battery (e.g., inductive heating, resistive heating, convection heating/fan by a charger or battery heating element) to prepare a battery pack 732 based on, for example, the expected time of use determined at block 804. In other embodiments, the electronic controller 714 (e.g., the charger controller 716) may activate a cooling function of the charger or battery (e.g., fan, Peltier cooling, or heat pump cooling by a charger or battery cooling element) to prepare a battery pack 732 based on, for example, the expected time of use determined at block 804, the temperature of the battery pack 732, and/or the temperature of the environment. For example, a battery pack 732 that is expected to be used power a tool in rigorous operation and in a hot environment may be cooled. By cooling the battery pack 732, the battery pack 732 is less likely to overheat and shutdown (e.g., based on the electronic controller 714 sensing that a temperature of the pack exceeds an over-temperature threshold and controlling the battery pack 732 to cease discharging), or at least the overheating and shutdown will occur later and provide more work time for a user. In some embodiments, the heating or cooling functions may be selected to prepare the battery pack 732 for charging by the power tool battery charger 702. In addition to identifying that the heating or cooling procedure should be performed on the battery pack 732, the electric controller 714 may also determine a rate of heating or cooling and a desired target temperature.

In some embodiments, the battery pack 732 and/or the charger 702 includes one or more temperature controlling elements (e.g., a heating and/or cooling element), such as a fan, Peltier cooling element, heat pump, resistive heating element, inductive heating element, and/or convention heating element/fan. Accordingly, the electronic controller 714 may activate a heating function by controlling a heating element (e.g., supplying current thereto) or may activate a cooling function by controlling a cooling element (e.g., supplying current thereto). In instances where one or more temperature controlling elements are within the charger 702, the charger 702 (and, in particular, the temperature controlling elements of the charger 702) may be coupled via a thermally conductive medium or element to the battery pack 732 to enable the heating and/or cooling function. For example, the thermally conductive medium or element may include an air pathway through openings or vents in one or both of the housings of the battery pack 732 and charger 702, and/or may include a thermally conductive material on each of the battery pack 732 and charger 702 that interface when the battery pack 732 is coupled to the charger 702). In the case of multiple techniques for heating or cooling a battery pack 732, the user may specify or request that a particular technique or techniques be employed for such heating or cooling (e.g., via an interface on the charger 702 or the battery pack 732). When multiple techniques are available to the charger 702 for heating and/or cooling a battery pack 732, the charger 702 may employ more than one such technique for heating battery pack 732 or cooling the battery pack 732, as the case may be.

In addition to or alternative to using heating and/or cooling elements integrated into the charger 702 or battery pack 732, the charger 702 may control environmental systems that control environmental characteristics of the environment in which the charger 702 is located. For example, the charger 702 may communicate with a heating, ventilation, and air conditioning (HVAC) system of a trailer, vehicle, or room of a building in which the charger 702 is located to control the HVAC system to heat or cool the surrounding environment. This heating or cooling will adjust the ambient temperature of the charger 702 and battery pack 732 and, ultimately, adjust the temperature of the battery pack 732. Accordingly, the charger can control the environmental system to heat or cool using similar principles for determining when and how to heat or cool a battery pack as discussed above with respect to heating and cooling elements of the charger 702 and/or battery pack 732. In some examples, in addition to or alternatively to an HVAC system, the environmental system includes other heating or cooling elements, and/or other controllable elements, that the charger 702 controls to adjust characteristics of the environment, for example, by activating a fan, controlling a humidifier or dehumidifier to alter humidity, controlling a filter to filter air, changing incident sunlight (e.g., opening or closing blinds), controlling a source of thermal heat e.g., from a light or ultraviolet (UV) source), and/or increasing visibility to such power tool device (e.g., activating lights in a trailer or garage). In some examples, the charger 702 may balance the control of environmental systems for purposes of battery and charger operation with reducing or controlling jobsite energy usage and/or providing hospitable environmental conditions for workers. For example, a charger 702 may control an HVAC system of a residential building to cool slightly over a lunch break (when workers are known or expected to have vacated) so that the battery pack(s) 732 may get to a lower temperature before afternoon use.

In some examples, the machine learning controller 710 may include the machine learning control 744 (see FIG. 7B) that has been trained, using techniques described above, with training data including examples of the set of data (e.g., of the same type received in block 802) labeled with an indication of a type of maintenance that should occur. In block 804, the processor 724 of the machine learning controller 710 may then execute the (trained) machine learning control 744 on the set of data (received in block 802) to determine the one or more maintenance procedures to be performed on the power tool battery pack.

In some examples, block 806 may be executed before block 804 to determine the type of maintenance procedure(s) to be performed before the time at which these maintenance procedures should be performed. The particular time for the maintenance procedure may be determined, in part, based on the type of maintenance procedure.

As explained above, the timing of a maintenance procedure (determined in block 804), the type of maintenance procedure (determined in block 806), and performance characteristics of the maintenance procedure (which may also be determined as part of block 806) may be based on likely working hours of the pack, settings, past usage data, the temperatures of the pack, the temperatures of the working environment, weather conditions, among other information.

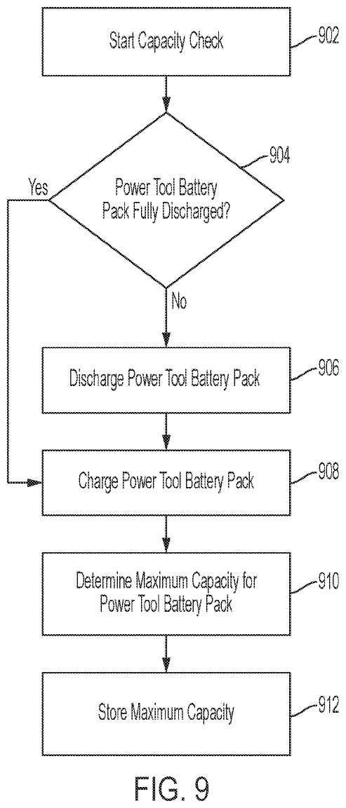

In block 808, the one or more maintenance procedures may be performed on the power tool battery pack 732 at the determined time using the power tool battery charger 702. In some embodiments, the charger controller 716 may receive the time for performing a maintenance procedure on the battery pack 732 and any maintenance procedure identified for the battery pack 732 from the machine learning controller 710. The charger controller 716 may then control the power tool battery charger 702 to perform any identified maintenance procedures on the battery pack 732 at the determined time when the battery pack 732 is connected to the power tool battery charger 702. For example, the electronic controller 714 may perform a capacity check known methods. In another example, the electronic controller 714 performs a capacity check of a battery pack 732 by fully discharging the battery pack and then fully charging the battery pack as discussed further below with respect to FIG. 9. In another example, in block 808, the electronic controller 714 performs cell balancing using known methods. In some embodiments, in block 808, to perform cell balancing, the power tool battery pack charger 702 inductively heats certain sections of the battery pack 732 to cause temperature imbalance that can result in cell rebalancing. A cell imbalance in a battery pack can indicate that some, often small, shorts have occurred within the battery pack or that a cell may have been damaged. It can often take days to weeks for the battery pack to reach an unusable charge level. Upon detecting a cell imbalance, the power tool battery charger 702 may be configured to detect and provide information to a user (e.g., using display 720 or external device 704) that may indicate and be used to detect trends in cell imbalance for the battery pack 732 that may indicate that the battery pack was shorted, damaged, and/or may not live for a long time. For example, the electronic controller 714 may generate an alert to be displayed on display 720 that alerts a user the battery pack 732 will die shortly. In some embodiments, in block 808, the power tool battery charger 702 may be used to revive the battery pack 732. In some embodiments, in block 808, the power tool battery charger 702 may be used to preemptively “brick” the battery pack 732 (i.e., to disable and make the battery pack unusable) because the battery pack 732 may be damaged. In some embodiments, in block 808, the power tool battery charger 702 may provide instructions (e.g., over network 708 to server 706) to order a replacement battery pack, for example, if the battery pack or an associated power tool is provided under a rental agreement or is under warranty. In some embodiments, to perform the maintenance procedure in block 808, the power tool battery charger 702 may heat or cool the battery pack 732 using the above-described techniques for heating and cooling, respectively.

As mentioned, a capacity check of a battery pack 732 may be performed by fully discharging the battery pack and then fully charging the battery pack. FIG. 9 illustrates a method for performing a capacity check of a power tool battery pack in accordance with an embodiment. The process illustrated in FIG. 9 is described below as being carried out by the power tool battery charger 702 according to the electronic controller 714, the machine learning controller 710, and/or a charger controller 716 as illustrated in FIGS. 7A-C or alternatively according to an artificial intelligence controller as described above. However, in some embodiments, the process is implemented by another power tool battery charger having additional, fewer, and/or alternative components, or integrated into another device (e.g., a portable power supply or inverter). In some embodiments, a controller of a portable power supply or inverter (rather than a charger), which may be similar to one of the controllers described herein, implements the process of FIG. 9. Additionally, although the blocks of the process are illustrated in a particular order, in some embodiments, one or more of the blocks may be executed partially or entirely in parallel, may be executed in a different order than illustrated in FIG. 9, or may be bypassed.

In block 902, the capacity check of a power tool battery pack 732 by the power tool battery pack charger 702 is started. In some embodiments, the charger controller 716 may initiate the capacity check in response to information from the machine learning controller 710 identifying the capacity check as a maintenance procedure to be performed and the time for performing the maintenance procedure. In some embodiments, the capacity check may be initiated by a user using, for example, a user interface 722 or an external device 704. In block 904, the charger 702 determines whether the power tool battery pack 732 is fully discharged. In some embodiments, the power tool battery charger 702 may receive information regarding the charge level of the battery pack 732 from the battery pack 732 or may use known methods to determine the charge level of the battery pack 732. For example, the charger 702 may sense the open circuit voltage across positive and negative terminals of the battery pack 732 using a voltage sensor, and access a lookup table or formula that maps open circuit voltage to a state of charge for the battery pack 732.

In block 904, the charger 702 may then compare the charge level of the battery pack 732 to a discharge threshold and determine that the battery pack 732 is fully discharged when the charge level is below the discharge threshold, and not fully discharged when the charge level is above the discharge threshold.

If the power tool battery pack 732 is fully discharged at block 904, the process proceeds to block 908. If the power tool battery pack 732 is not fully discharged at block 904, the power tool battery charger 702 is used to fully discharge the power tool battery pack 732 in block 906. In some embodiments, the charger controller 716 can operate the power tool battery charger 702 to fully discharge the battery pack 732. For example, the charger controller 716 may control a switch to connect a resistive element of the charger 702 to the terminals of the power tool battery pack 732 to discharge the battery pack 732. Although the charger controller 716 operates the power tool battery charger 702 to fully discharge the battery pack 732 in the flow chart of FIG. 9, in some embodiments, the power tool battery pack 732 may be partially discharged at block 906 (e.g., until the state of charge is below a partially discharged threshold that is greater than the discharge threshold).

In block 908, the power tool battery charger 702 is used to charge the power tool battery pack 732. The power tool battery charger 702 may charge the power tool battery pack 732 using one or more charging techniques, such as constant current charging, constant voltage charging, constant current/constant voltage charting, trickle charging, and the like. For example, the charger controller 716 may control a power switching element (e.g., a field effect transistor or bipolar junction transistor) positioned between a power source for the power tool battery charger 702 and an output of the battery pack interface 712 to close (to permit charging), to open (to cease charging), and/or to open and close at a frequency or duty cycle to adjust a charge current up or down. For example, the charger 702 may include an AC power interface configured to be coupled to an AC source (e.g., via a wall outlet, a portable power supply, or the like). This AC power interface may include an AC/DC converter that converts received AC power (e.g., at 60 Hz, 120 V) to DC power (e.g., at 24 V, 18 V, or 12). The output of the AC/DC converter may be connected, via a power line with the power switching element, to an output (charging) terminal of the battery pack interface 712. Accordingly, controlling this power switching element to open will open a circuit between the power source (the AC power interface) and a battery pack connected to the battery pack interface 712 (to interrupt or prevent charging), and controlling this power switching element to close will close the circuit between the power source and a battery pack connected to the battery pack interface 712 (to permit charging). Further, increasing the duty cycle of a control signal controlling a power switching element may increase the percentage of time that the power switching element is closed (to permit charging) relative to the power switching element being open (to cease charging), thereby increasing the charge current over a given time period. Similarly, decreasing the duty cycle may decrease the charge current over a given time period.

The charger 702 may monitor the state of charge of the battery pack 732 during the charging process (e.g., by sensing the open circuit voltage of the battery pack 732), and may continue to charge the battery pack 732 until the battery pack 732 reaches a fully charged threshold, or to a partially charged threshold that is less than the fully charged threshold.

In block 910, the maximum capacity of the power tool battery pack is determined. In some embodiments, the maximum capacity may be determined by performing Coulomb counting while the battery pack 732 is charged at block 908. In block 912, the maximum capacity of the power tool battery pack may be updated and stored in a memory. In some embodiments, the maximum capacity may be associated with a unique identifier (ID) of the power tool battery pack 732. In some embodiments, a maximum capacity determination involves a full discharge and/or a full recharge of the battery pack 732. In some embodiments, a maximum capacity determination involves a partial discharge and/or a partial recharge of the battery pack 732. In some examples, the battery charger 702 further outputs the maximum capacity determined in block 910, for example, on a display of the charger 702, to the external device 704 (e.g., to display on a screen thereof, and/or to store or further disseminate the information), to the server 706 (for storage and/or further dissemination), and/or to the battery pack 732 (for storage and/or further dissemination).

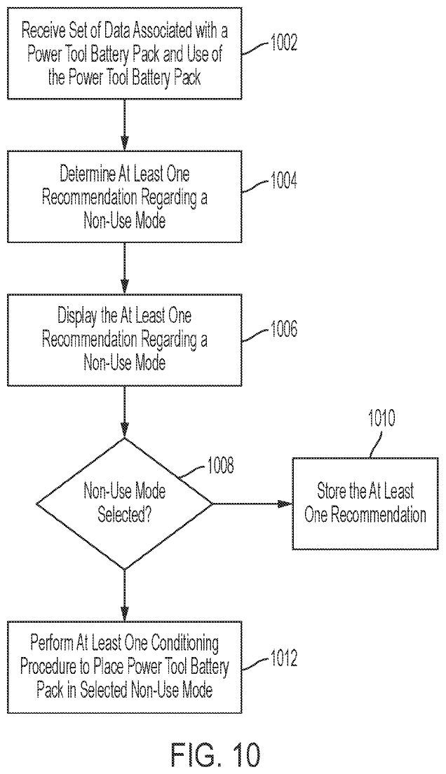

As mentioned above, the power tool battery charger 702 (e.g., electronic controller 714) may be configured to determine recommendations regarding a non-use mode for a power tool battery pack. FIG. 10 illustrates a method for determining recommendations for a non-use mode of a power tool battery pack in accordance with an embodiment. The process illustrated in FIG. 10 is described below as being carried out by the power tool battery charger 702 according to the electronic controller 714, the machine learning controller 710, and/or a charger controller 716 as illustrated in FIGS. 7A-C or alternatively according to an artificial intelligence controller as described above. However, in some embodiments, the process is implemented by another power tool battery charger having additional, fewer, and/or alternative components, or integrated into another device (e.g., a portable power supply or inverter). In some embodiments, a controller of a portable power supply or inverter (rather than a charger), which may be similar to one of the controllers described herein, implements the process of FIG. 10. Additionally, although the blocks of the process are illustrated in a particular order, in some embodiments, one or more of the blocks may be executed partially or entirely in parallel, may be executed in a different order than illustrated in FIG. 10, or may be bypassed.

In block 1002, a power tool battery pack charger 702 receives a set of data associated with a power tool battery pack and use of the power tool battery pack 732. In some embodiments, block 1002 may be similar to block 802 described above. Accordingly, as described above, the set of data may include, for example, power tool device data which, as mentioned above, may include usage data, maintenance data, operator data, location data, user settings data, among other data.

In block 1004, the received set of data is used to determine at least one recommendation regarding a non-use mode of the power tool battery pack 732. The received set of data may be analyzed using, for example, the electronic controller 714 of the power tool battery pack charger 702. In some embodiments, the set of data may be analyzed using a machine learning controller 710 (e.g., executing machine learning control 744) included in the electronic controller 714. In some embodiments, the set of data may be analyzed using the charger controller 716 included in the electronic controller 714. In some embodiments, the non-use modes include, for example, a recycling mode, a disposal mode, a transport mode, a storage mode, and a repair mode. In some embodiments, the recommendation regarding a non-use mode may include a recommendation regarding a conditioning procedure that may be used to place the power tool battery pack 732 in the selected non-use mode. For example, for a battery pack 732 to be recycled, disposed of, transported, repaired, or stored for a period of time, there may be desired or ideal conditions and/or requirements surrounding, for example, the charge level of the battery pack 732 (e.g., to have the charge level at a certain level, below a certain level, above a certain level, or within a certain range).

In one example, data including, but not limited to, remaining capacity of the power tool battery pack 732, data regarding past drops of the power tool battery pack 732, cell imbalance, quiescent current, and charge rate may be used to determine whether a power tool battery pack 732 is suitable for recycling, suitable for repair, or whether the battery pack will be recommended for disposal (e.g., if the battery pack is too damaged or too worn). If it is determined that the battery pack is suitable for recycling, a recycling mode recommendation may also include a recommendation for acquiring more of the same battery pack or different battery packs, e.g., for a jobsite, users, group of users, tool(s), etc. In some embodiments, a battery pack 732 under warranty that has been determined suitable for recycling or disposal may be automatically replaced by providing order instructions from the power tool battery charger 702 to an external device 704 or server 706. Accordingly, in such embodiments, the charger 702 may automatically request a replacement battery to be shipped without having a user request a replacement. In some embodiment, the recommendation regarding a recycling mode may also include information regarding a recycling incentive (e.g., a monetary value) that may be associated with the remaining usefulness of the battery pack 732. In some embodiments, if a cell imbalance of a battery pack 732 indicates that only one or a few cells may be unsuitable in a larger battery pack with many cells, the recommendation for recycling may include a recommendation to recycle the battery pack 732, and/or may indicate to recycle only the “good” cells of the battery pack 732. In some embodiments, the determination of whether to recommend recycling, repair, or disposal is based on the number of “good cells” remaining exceeding a threshold (e.g., if greater than a first threshold number, recommend repair, if less than a second threshold number, recommend disposal, if in between the first and second threshold number, recommend recycle). In some embodiments, a recommendation regarding disposal for a battery pack 732 may include a recommendation to dispose of the battery pack in a particular way. In some embodiments, a recommendation regarding shipment mode or a storage mode may indicate to not ship or store a battery pack 732 based on aspects of the battery pack 732.

In some embodiments, in block 1004, rather than determining a recommendation regarding a non-use mode, the battery charger 702 determines a recommendation regarding an alternate use (also referred to as a re-use or limited use) based on the received set of data. For example, the battery charger 702 may determine that the battery pack 732 has diminished capacity (e.g., from use and wear over time) and may no longer provide satisfactory performance for power tools with high power demands. Accordingly, the battery charger 702 may determine an alternate use recommendation for the battery pack 732, such as a recommendation to be used on lower power draw applications (e.g., to power lights or fans). Such recommendation may be communicated to the user (e.g., by display on display 720 of the power tool battery charger 702, on display 738 of the power tool battery pack 732, and/or on display 766 of the external device 704), and the charger 702 may then exit the process of FIG. 10.

In some embodiments, to determine the recommendation, the machine learning controller 710 takes the received set of data as an input and generates a metric (e.g., a numerical value) indicative of a characteristic of the battery pack 732, such as a battery health. For example, the machine learning controller 710 may include the machine learning control 744 (see FIG. 7B) that has been trained, using techniques described above, with training data including examples of the set of data (e.g., of the same type received in block 1002) labeled with a metric indicative of a characteristic of a battery pack. In block 1004, the processor 724 of the machine learning controller 710 may then execute the (trained) machine learning control 744 to receive and process the set of data (received in block 1002) to determine and output the metric. The metric may then be mapped (e.g., by a lookup table including ranges of metrics) to one of the non-use modes (or an alternate use). In some cases, the metric may further be mapped to a degree to which a particular recommendation is being suggested (e.g., strongly recommend disposal versus recommend disposal). In some cases, the labels for the training data includes the potential recommendations regarding non-use modes, and the output of machine learning controller executing the (trained) machine learning control 744 is the recommendation regarding the non-use mode, rather than a metric that is then used to determine the recommendation. In some cases, the metric may be (or may be mapped to) a market value for the battery pack 732, a monetary offer for a return of the battery pack 732 (e.g., for recycling or repair and reuse), or a qualitative or quantitative metric about the battery pack 732.

In block 1006, the at least one recommendation regarding a non-use mode of the power tool battery pack 732 may be displayed, for example, on display 720 of the power tool battery charger 702, on display 738 of the power tool battery pack 732, and/or on display 766 of the external device 704. For example, the electronic controller 714 may control the display 720 to display the recommendation, and/or may output the recommendation to the power tool battery pack 732 and/or the external device 704. The power tool battery pack 732 and/or the external device 704 may display the received recommendation.

In block 1008, the battery charger 702 determines whether a non-use mode, for example, one or more of the recommended non-use modes, has been selected. In some embodiments, based on displayed recommendations at block 1006, a user may select the recommended non-use mode for the battery pack 732, for example, using the user interface 722 or an external device 704. In some embodiments, in block 1008, a recommendation determined in block 1004, which may or may not be displayed in block 1006, is selected automatically (without a user selection) by the battery charger 702. For example, the battery charger 702 may select the highest ranked recommendation or use another selection criterion. If a non-use mode (e.g., a recommended non-use mode from block 1004 and 1006) has not been selected at block 1008, the process proceeds to block 1010 and the at least one recommendation may be stored in a memory at block 1010. For example, the battery charger 702 may store the recommendation in a memory of the electronic controller 714, the memory 742, the memory 752, and/or the memory 764.

If a non-use mode (e.g., a recommended non-use mode from block 1004 and 1006) has been selected at block 1008, the process proceeds to block 1012 and the power tool battery charger 702 may be used to perform at least one conditioning procedure to place the power tool battery pack 732 in the selected non-use mode. In some embodiments, the recommendation regarding a non-use mode may include a recommendation regarding one or more conditioning procedures to perform on the battery pack 732 in preparation for recycling, disposing, transport, repair, or storage. In some embodiments, one or more conditioning procedures may be associated with each non-use mode and stored in a memory. When a non-use mode is selected (e.g., by a user or automatically by the charger 702 based on the at least one recommendation), the associated conditioning procedure(s) may be retrieved from memory and performed by the power tool battery charger 702. In some embodiments, for a battery pack 732 to be recycled, disposed of, transported, repaired, or stored for a period of time, there may be desired or ideal conditions and/or requirements surrounding, for example, the charge level of the battery pack 732. In this example, it may be desirable to charge or discharge the battery pack 732 to a particular level or range, or to perform a particular maintenance procedure on the battery pack 732. Accordingly, the charger 702 may discharge the battery pack 732 to the particular desired level or range (e.g., using similar procedure as described with respect to block 906 of FIG. 9).

In some embodiments, the non-use mode is a recycling mode, a disposal mode, repair mode, or a transport mode and the conditioning procedure includes discharging or the battery pack 732 (e.g., using the power tool battery charger 702) to a target charge or discharge level. In some embodiments, a user may request that a battery pack 732 be discharged. For example, the user may provide a request using user interface 722 or an external device 704. The request may indicate approval by the user of a recommended conditioning procedure indicated on a display in block 1006. The request may include, for example, a target charge level and/or discharge level selected by the user or associated with the recommended non-use mode from block 1004 and 1006 and obtained by the charger 702 (e.g., from a memory that stores the level in associated with the recommended non-use mode). The charger 702 may then discharge the battery pack 732 to the particular desired level or range (e.g., using similar procedure as described with respect to block 906 of FIG. 9).

In some embodiments, the non-use mode is a disposal mode and the conditioning procedure may be to “brick” the battery pack 732 (i.e., to disable and make the battery pack unusable) because the battery pack 732 may be damaged. In some embodiments, to “brick” a battery pack 732, the power tool battery charger 702 may destroy an internal fuse or other component in the battery pack 732. For example, in some embodiments, the power tool battery charger 702 may “short” the battery pack 732 (e.g., closing a switch to connect a positive and negative terminal of the battery pack interface 712 and, thus, of the battery pack 732) such that an internal fuse reaches a destructive limit and thus permanently bricking or disabling the battery pack 732. In other embodiments, the battery pack 732 may have an additional heat generation system that can tailor heating of the battery pack 732 towards an internal fuse or other component in the battery pack 732 that makes the circuit incomplete. The additional heat generation system may be, for example, a small resistor and switch that may intentionally break a main fuse of the battery pack 732, thus disconnecting the main circuitry. The small resistive circuit may, for example, be powered internally from the battery pack 732 and/or externally (e.g., via separate pins powered by a power tool battery charger 702). Hard destructive “bricking” of a battery pack 732 can prevent any further use of the battery pack and may also make a final transport and/or disassembly easier. In some embodiments, the battery pack 732 is disabled through a software process in which a parameter is set that effectively renders the pack generally unusable.

In some embodiments, the non-use mode is a transport mode and the conditioning procedure may be to place the power tool battery charger 702 in a “prep for shipping mode” where the power tool battery charger 702 is used to charge or discharge the battery pack 732 to the highest allowable charge amount permissible by shipping regulations, or some other predetermined charge amount. Ensuring a charge level at the highest permissible level (e.g., 10%, 15%, or 25% of full charge), or another level, can help a battery pack 732 to avoid draining too low and damaging the battery pack 732 while idle during shipment for potentially extended periods of time. In some embodiments, information regarding how to ship and package a battery pack 732, where to deliver the battery pack 732, etc. may be provided on a display (e.g., the same display that the recommendation is displayed in block 1006), on an application (e.g., on an external device 704), on a Web-based portal, via cellular, text, website, and so on. For example, the charger 702 may display a recommendation to package a battery pack 732 is a particular way (e.g., with extra insulation, with an insulating component on the battery terminals, with a configurable switch on the battery pack 732 that opens the circuit, etc.), or the like, and may display a shipping address.

In some embodiments, the non-use mode is a transport or storage (e.g., long term storage) mode and the power tool battery charger 702 may be shipped or stored connected with a battery pack 732 or multiple battery packs 732 to implement block 1012. For example, in some embodiments, the power tool battery charger 702 may be configured to monitor the battery pack 732 (or multiple battery packs 732) during shipping or storage. In such embodiments, the power tool battery charger 702 may take energy from one battery pack to help keep another battery pack charged to a certain or substantial level. The power tool battery charger 702 may also take energy from a battery pack to power the electronic controller 714 to perform any functions during the shipping or storage process. For example, the power tool battery charger 702 may provide a location update during storage and transport (e.g., location from GNSS and or associated wireless connectivity, update from a wireless communication such as cellular, Wi-Fi, Bluetooth®, etc.). In some embodiments, in block 1012, for transport or storage with a battery pack 732 or multiple battery packs 732, the power tool battery charger 702 is put in a “keep battery pack alive” mode for which a battery pack (or packs) 732 is held at a midrange stable voltage. In some embodiments, the power tool battery charger 702, may also have a “life preservation” mode for transport or storage with multiple battery packs 732 where one battery pack is discharged to allow the power tool battery charger 702 to use the discharged power to provide minimal life (charge) for a second battery pack of a lower target voltage, even when the power tool battery charger 702 is unplugged. Thus, the power tool battery charger 702 can act as a transfer device of energy helping to preserve the life and utility of the battery packs 732.

In some embodiments, the power tool battery charger 702 is configured to implement a direct discharge feature in which a coupled battery pack 732 is discharged in response to a user request. The battery charger 702 may implement the direct discharge in response to a request from a user. The request may be received from a user, for example, via the user interface 722 of the battery charger 702 or via a user interface of the external device 704. To discharge the battery pack 732, the electronic controller 714 may control a switch to connect a resistive element of the battery charger 702 to power terminals of the power tool battery pack 732 such that current from the battery pack 732 flows through the resistive element and is converted into and dissipated as heat energy. The battery charger 702 may monitor the charge level of the battery pack 732 during the discharging (e.g., by measuring open circuit voltage of the battery pack 732). The battery charger 702 may discharge the battery pack 732 fully (e.g., to a low voltage cut-off level) or to another low charge level threshold. The low charge level threshold may be predetermined (e.g., indicated in a memory of the battery pack 732 or the electronic controller 714) or received from a user via the user interface 722.

In some embodiments, the power tool battery charger 702 has a user interface configured to receive a user selection of one or more of the non-use modes described herein. For example, the display 720 may display non-use modes available for selection by a user (e.g., in a list or grid format) and the user interface 722 may have one or more push buttons, knobs, dials, or the like that enable a user to navigate and select one of the displayed non-use modes, or the display 720 and user interface 722 may be combined into a touch screen to enable such display, navigation, and selection. In response to receiving a selection of one of the non-use modes, the battery charger 702 may then proceed to perform the at least one conditioning procedures associated with the selected non-use mode, as described with respect to block 1012.

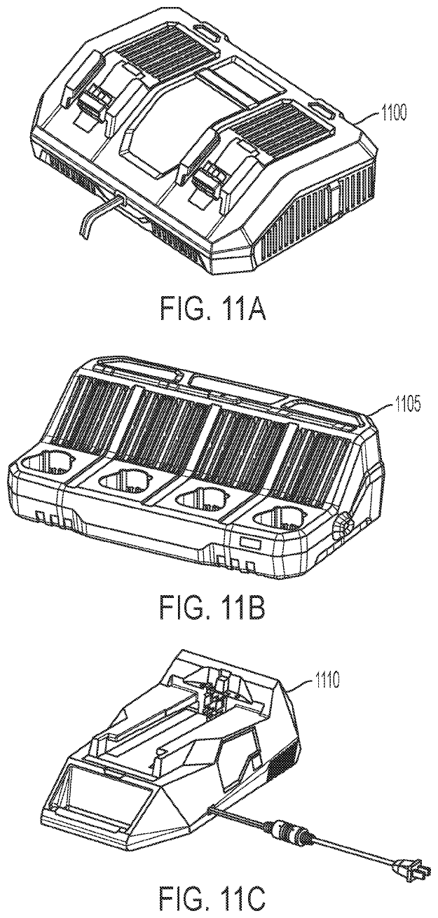

The power tool battery pack(s) 630, 732 and power tool battery charger(s) 102, 202, 302, 402, 502, and 702 described herein are just some examples of such packs and chargers. In some embodiments, the power tool battery charger(s) 102, 202, 302, 402, 502, and 702 have another configuration. For example, the power tool battery charger(s) 102, 202, 302, 402, 502, and 702 may have additional or fewer charging docks, may have a different electrical and/or mechanical interface for interfacing with a power tool battery pack, and/or may be configured to charge a different type (or combinations of types) of power tool battery packs (e.g., having different capacities or nominal voltage levels). For example, FIGS. 11A-11C illustrate three further examples of power tool battery chargers 1100, 1105, and 1110. Each of the power tool battery pack chargers 1100, 1105, and 1110 may perform the functionality of the power tool battery charger(s) 102, 202, 302, 402, 502, and 702 above. For example, one or more of the chargers 1100, 1105, and 1110 may be configured to implement the processes described above with respect to FIGS. 8-10. Additionally, at least in some embodiments, the diagram(s) of the power tool battery charger(s) 702 of FIG. 7A-7C similarly applies to the chargers 1100, 1105, and 1110.

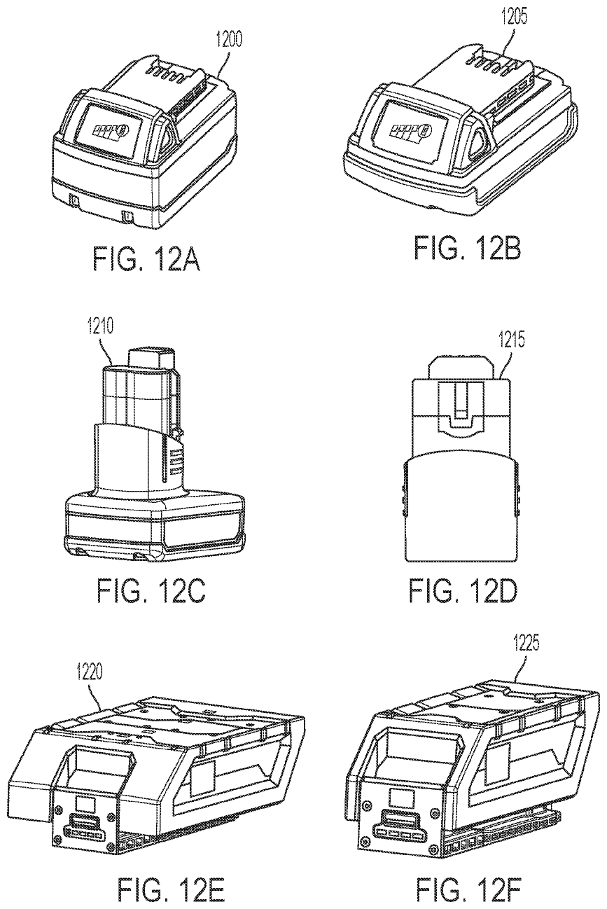

Similarly, in some embodiments, the power tool battery pack(s) 630, 732 have another configuration. For example, the power tool battery pack(s) 630, 732 may have a different electrical and/or mechanical interface for interfacing with power tools and/or power tool battery pack chargers and/or may be configured to be charged by a different type of power tool battery chargers (e.g., one or more of the chargers 1100, 1105, 1110), may have a different capacity, and/or may have a different nominal voltage level. For example, FIGS. 12A-12F illustrate six further examples of power tool battery packs 1200, 1205, 1210, 1215, 1220, 1225. Each of the power tool battery packs 1200-1225 may perform the functionality of the power tool battery pack(s) 630, 732 above. Additionally, at least in some embodiments, the diagram(s) of the power tool battery pack(s) 732 of FIG. 7A similarly applies to the packs 1200-1225.

FIGS. 11A-C respectively illustrate the power tool battery pack chargers 1100, 1105, and 1110. As illustrated, the charger 1100 includes two charging docks, the charger 1105 includes four charging docks, and the charger 1110 includes one charging dock. Each charging dock is configured to receive and provide charging current to one power tool battery pack at a time. To receive a power tool battery pack, the charging dock may electrically and mechanically interface with the power tool battery pack. Accordingly, each of the chargers 1100, 1105, and 1110 is configured to electrically and mechanically interface with a power tool battery pack via each respective charging dock. Electrically interfacing may include electrical terminals of the pack and a charger (e.g., one of the respective chargers 1100, 1105, and 1110) contacting one another, may include a wireless connection for wireless power transfer (e.g., between inductive or capacitive elements of the pack and the charger, or a combination thereof. Mechanical interfacing may include the pack being received in a receptacle of a charger (e.g., one of the respective chargers 1100, 1105, and 1110), a mating of physical retention structures of the pack and the charger, or a combination thereof. In some examples, the charger 1100 includes fewer or additional charging docks. In some examples, the charger 1105 includes fewer or additional charging docks. In some examples, the charger 1110 includes fewer or additional charging docks. In some examples, the power tool battery pack charger 1100 is configured to receive and charge power tool battery packs (e.g., packs 1200 and 1205) having a nominal voltage of approximately 18 volts, a nominal voltage between 16 volts and 22 volts, or another amount. In some examples, the power tool battery pack charger 1105 is configured to receive and charge power tool battery packs (e.g., packs 1210 and 1215) having a nominal voltage of approximately 12 volts, a nominal voltage between 8 volts and 16 volts, or another amount. In some examples, the power tool battery pack charger 1110 is configured to receive and charge power tool battery packs (e.g., packs 1220 and 1225) having a nominal voltage of approximately 72 volts, a nominal voltage between 60 volts and 90 volts, or another amount. Accordingly, at least in some embodiments, the charger 1110 is generally configured to charge battery packs having a higher nominal voltage than the packs charged by the chargers 1105 and 1100, and the charger 1100 is generally configured to charge battery packs having a higher nominal voltage than the packs charged by the charger 1105.

FIGS. 12A-F respectively illustrate the power tool battery packs 1200, 1205, 1210, 1215,1 220, and 1225. Each pack 12001-225 is configured to be received and charged by a power tool battery charger (e.g., one of the chargers 1100, 1105, and 1110). Each pack 1200-1225 is further configured to be received by provide power to a power tool. To be received by a charger or power tool, teach battery pack 1200-1225 may electrically and mechanically interface with the charger and (at a different time) with a power tool. In some examples, the power tool battery packs 1200 and 1205 have a first nominal voltage of approximately 18 volts, of between 16 volts and 22 volts, or another amount. In some examples, the power tool battery pack 1200 has a larger capacity than the pack 1205, generally providing a longer run time than the pack 1205 when operating under similar circumstances. To achieve additional capacity, the pack 1200 may include an additional set of battery cells relative to the pack 1205. For example, the pack 1205 may include a set of series-connected battery cells, while the battery pack 1205 may include two or more sets of series-connected battery cells, with each set being connected in parallel to the other set(s) of cells.

In some examples, the power tool battery packs 1210 and 1215 have a second nominal voltage of approximately 12 volts, of between 8 volts and 16 volts, or another amount. In some examples, the power tool battery pack 1210 has a larger capacity than the pack 1215, generally providing a longer run time than the pack 1215 when operating under similar circumstances. To achieve additional capacity, the pack 1210 may include an additional set of battery cells relative to the pack 1215. For example, the pack 1215 may include a set of series-connected battery cells, while the battery pack 1210 may include two or more sets of series-connected battery cells, with each set being connected in parallel to the other set(s) of cells.

In some examples, the power tool battery packs 1220 and 1225 have a third nominal voltage of approximately 72 volts, of between 60 volts and 90 volts, or another amount. In some examples, the power tool battery pack 1220 has a larger capacity than the pack 1225, generally providing a longer run time than the pack 1225 when operating under similar circumstances. To achieve additional capacity, the pack 1220 may include an additional set of battery cells relative to the pack 1225. For example, the pack 1225 may include a set of series-connected battery cells, while the battery pack 1220 may include two or more sets of series-connected battery cells, with each set being connected in parallel to the other set(s) of cells.

Accordingly, at least in some embodiments, the packs 1220 and 1225 have a higher nominal voltage than the packs 1200, 1205, 1210, and 1215, and the packs 1200 and 1205 have a higher nominal voltage than the packs 1210 and 1215.

It is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

As used herein, unless otherwise limited or defined, discussion of particular directions is provided by example only, with regard to particular embodiments or relevant illustrations. For example, discussion of “top,” “front,” or “back” features is generally intended as a description only of the orientation of such features relative to a reference frame of a particular example or illustration. Correspondingly, for example, a “top” feature may sometimes be disposed below a “bottom” feature (and so on), in some arrangements or embodiments. Further, references to particular rotational or other movements (e.g., counterclockwise rotation) is generally intended as a description only of movement relative a reference frame of a particular example of illustration.

In some embodiments, including computerized implementations of methods according to the disclosure, can be implemented as a system, method, apparatus, or article of manufacture using standard programming or engineering techniques to produce software, firmware, hardware, or any combination thereof to control a processor device (e.g., a serial or parallel processor chip, a single- or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, embodiments of the disclosure can be implemented as a set of instructions, tangibly embodied on a non-transitory computer-readable media, such that a processor device can implement the instructions based upon reading the instructions from the computer-readable media. Some embodiments of the disclosure can include (or utilize) a control device such as an automation device, a computer including various computer hardware, software, firmware, and so on, consistent with the discussion below. As specific examples, a control device can include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.). Also, functions performed by multiple components may be consolidated and performed by a single component. Similarly, the functions described herein as being performed by one component may be performed by multiple components in a distributed manner. Additionally, a component described as performing particular functionality may also perform additional functionality not described herein. For example, a device or structure that is “configured” in a certain way is configured in at least that way, but may also be configured in ways that are not listed.

The term “article of manufacture” as used herein is intended to encompass a computer program accessible from any computer-readable device, carrier (e.g., non-transitory signals), or media (e.g., non-transitory media). For example, computer-readable media can include but are not limited to magnetic storage devices (e.g., hard disk, floppy disk, magnetic strips, and so on), optical disks (e.g., compact disk (CD), digital versatile disk (DVD), and so on), smart cards, and flash memory devices (e.g., card, stick, and so on). Additionally it should be appreciated that a carrier wave can be employed to carry computer-readable electronic data such as those used in transmitting and receiving electronic mail or in accessing a network such as the Internet or a local area network (LAN). Those skilled in the art will recognize that many modifications may be made to these configurations without departing from the scope or spirit of the claimed subject matter.

Certain operations of methods according to the disclosure, or of systems executing those methods, may be represented schematically in the figures or otherwise discussed herein. Unless otherwise specified or limited, representation in the figures of particular operations in particular spatial order may not necessarily require those operations to be executed in a particular sequence corresponding to the particular spatial order. Correspondingly, certain operations represented in the figures, or otherwise disclosed herein, can be executed in different orders than are expressly illustrated or described, as appropriate for particular embodiments of the disclosure. Further, in some embodiments, certain operations can be executed in parallel, including by dedicated parallel processing devices, or separate computing devices configured to interoperate as part of a large system.

As used herein in the context of computer implementation, unless otherwise specified or limited, the terms “component,” “system,” “module,” and the like are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) may reside within a process or thread of execution, may be localized on one computer, may be distributed between two or more computers or other processor devices, or may be included within another component (or system, module, and so on).

In some implementations, devices or systems disclosed herein can be utilized or installed using methods embodying aspects of the disclosure. Correspondingly, description herein of particular features, capabilities, or intended purposes of a device or system is generally intended to inherently include disclosure of a method of using such features for the intended purposes, a method of implementing such capabilities, and a method of installing disclosed (or otherwise known) components to support these purposes or capabilities. Similarly, unless otherwise indicated or limited, discussion herein of any method of manufacturing or using a particular device or system, including installing the device or system, is intended to inherently include disclosure, as embodiments of the disclosure, of the utilized features and implemented capabilities of such device or system.

As used herein, unless otherwise defined or limited, ordinal numbers are used herein for convenience of reference based generally on the order in which particular components are presented for the relevant part of the disclosure. In this regard, for example, designations such as “first,” “second,” etc., generally indicate only the order in which the relevant component is introduced for discussion and generally do not indicate or require a particular spatial arrangement, functional or structural primacy or order.

As used herein, unless otherwise defined or limited, directional terms are used for convenience of reference for discussion of particular figures or examples. For example, references to downward (or other) directions or top (or other) positions may be used to discuss aspects of a particular example or figure, but do not necessarily require similar orientation or geometry in all installations or configurations.

As used herein, unless otherwise defined or limited, the phase “and/or” used with two or more items is intended to cover the items individually and the items together. For example, a device having “a and/or b” is intended to cover: a device having a (but not b); a device having b (but not a); and a device having both a and b.

This discussion is presented to enable a person skilled in the art to make and use embodiments of the disclosure. Various modifications to the illustrated examples will be readily apparent to those skilled in the art, and the generic principles herein can be applied to other examples and applications without departing from the principles disclosed herein. Thus, embodiments of the disclosure are not intended to be limited to embodiments shown, but are to be accorded the widest scope consistent with the principles and features disclosed herein and the claims below. The following detailed description is to be read with reference to the figures, in which like elements in different figures have like reference numerals. The figures, which are not necessarily to scale, depict selected examples and are not intended to limit the scope of the disclosure. Skilled artisans will recognize the examples provided herein have many useful alternatives and fall within the scope of the disclosure.

Various features and advantages of the disclosure are set forth in the following claims.

1. A power tool battery charger comprising:
a battery pack interface configured to receive a power tool battery pack and provide charging current to the battery pack; and
an electronic controller including a processor, the electronic controller configured to:
receive a set of data associated with the power tool battery pack and use of the power tool battery pack;
determine a time for performing a maintenance procedure based on the set of data wherein the maintenance procedure is at least one selected from a group of determining a maximum capacity of the power tool battery pack, cell balancing, cooling the power tool battery pack, and heating the power tool batty pack;
determine one or more maintenance procedures to be performed on the power tool battery pack based on the set of data; and
perform the one or more maintenance procedures on the power tool battery pack at the determined time.

2. The power tool battery charger according to claim 1,
wherein the electronic controller further includes a charger controller including the processor, and a machine learning controller including a second processor and a machine learning control program;
wherein the machine learning controller is configured to:
receive the set of data associated with the power tool battery pack and use of the power tool battery pack;
determine, using the machine learning program, the time for performing the maintenance procedure based on the set of data; and
determine, using the machine learning program, the one or more maintenance procedures to be performed on the power tool battery pack based on the set of data; and
wherein the charger controller is configured to perform the one or more maintenance procedures on the power tool battery pack at the determined time.

3. The power tool battery charger according to claim 1, wherein the maintenance procedure is to determine the maximum capacity of the power tool battery pack.

4. The power tool battery charger according to claim 1, wherein the maintenance procedure is cell balancing.

5. The power tool battery charger according to claim 1, wherein the maintenance procedure includes cooling the power tool battery pack.

6. The power tool battery charger according to claim 1, wherein the maintenance procedure includes heating the power tool battery pack.

7. A method for performing a maintenance procedure on a power tool battery pack, the method comprising:
receiving, using an electronic controller, a set of data associated with the power tool battery pack and use of the power tool battery pack;
determining, using the electronic controller, a time for performing a maintenance procedure based on the set of data, wherein the maintenance procedure is at least one selected from a group of determining a maximum capacity of the power tool battery pack, cell balancing, cooling the power tool battery pack, and heating the power tool batty pack;
determining, using the electronic controller, one or more maintenance procedures to be performed on the power tool battery pack based on the set of data; and
performing, using a power tool battery charger, the one or more maintenance procedures on the power tool battery pack at the determined time.

8. The method according to claim 7, the set of data includes one or more of a time of day, a day of week, a history of use of the power tool battery pack, temperature, charge level of the power tool battery pack, amount of time since the one or more maintenance procedures were previously performed, power tool battery pack usage information, information regarding whether the power tool battery pack was dropped, weather information, geography information, or a type of power tool used with the power tool battery pack.

9. The method according to claim 7, wherein determining one or more maintenance procedures to be performed includes determining whether to perform the one or more maintenance procedures at the determined time.

10. The method according to claim 7, wherein the maintenance procedure is to determine the maximum capacity of the power tool battery pack.

11. The method according to claim 7, wherein the maintenance procedure is cell balancing.

12. The method according to claim 7, wherein the maintenance procedure includes cooling the power tool battery pack.

13. The method according to claim 7, wherein the maintenance procedure includes heating the power tool battery pack.

14.-21. (canceled)

22. The method according to claim 7, wherein the electronic controller includes a charger controller and a machine learning controller, and wherein determining the time for performing the maintenance procedure based on the set of data comprises:
receiving, by the machine learning controller, the set of data;
determining, by the machine learning controller, the time for performing the maintenance procedure based on the set of data; and

23. The method according to claim 22, wherein determining the one or more maintenance procedures based on the set of data comprises:
determining, using the machine learning controller, the one or more maintenance procedures to be performed on the power tool battery pack based on the set of data.

24. The method according to claim 23, wherein performing the one or more maintenance procedures comprises:
performing, by the charger controller, the one or more maintenance procedures on the power tool battery pack at the determined time.

25. The power tool battery charger according to claim 1, wherein the set of data includes one or more of a time of day, a day of week, a history of use of the power tool battery pack, temperature, charge level of the power tool battery pack, amount of time since the one or more maintenance procedures were previously performed, power tool battery pack usage information, information regarding whether the power tool battery pack was dropped, weather information, geography information, or a type of power tool used with the power tool battery pack.

26. The power tool battery charger according to claim 1, wherein the electronic controller further includes a charger controller including the processor, and a machine learning controller including a second processor and a machine learning control program;
wherein the machine learning controller is configured to determine, using the machine learning program, the time for performing the maintenance procedure based on the set of data; and
wherein the charger controller is configured to perform the one or more maintenance procedures on the power tool battery pack at the determined time.

27. The power tool battery charger according to claim 1, wherein the electronic controller further includes a charger controller including the processor, and a machine learning controller including a second processor and a machine learning control program;
wherein the machine learning controller is configured to determine, using the machine learning program, the one or more maintenance procedures to be performed on the power tool battery pack based on the set of data.
